(19) United States
(12) Patent Application Publication
(10) Pub. No.: US 2004/0048180 A1
(43) Pub. Date: Mar. 11, 2004

(54) Electrophotographic method and photoreceptor for electrophotography used by the same

(75) Inventors: Satoshi Kojima, Numazu-shi (JP); Koji Yamazaki, Odawara-shi (JP); Toshiyuki Ehara, Yokohama-shi (JP); Kazuhiko Takada, Mishima-shi (JP); Masaya Kawada, Mishima-shi (JP); Hironori Ohwaki, Mishima-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/660,911

(22) Filed: Sep. 12, 2003

Related U.S. Application Data
(62) Division of application No. 09/865,699, filed on May 29, 2001, now abandoned.

(30) Foreign Application Priority Data
May 30, 2000 (JP) 2000-160400

(51) Int. Cl. G03G 13/06

(52) U.S. Cl. 430/69; 430/97; 399/159; 430/127

(57) ABSTRACT

There is provided an electrophotographic method, in which influence on an image quality attributable to the conditions of the photoreceptor surface is reduced and much sharper and high image quality having high resolution is obtained, when a spot size of the exposure light is made finer as progress is made in high resolution. In a digital exposure system electrophotographic method of a BAE system which performs scan-exposing for an image formation on a photoreceptor, a photoreceptor comprising a supporting member 401 comprising aluminum or an aluminum alloy and a photosensitive layer 402 deposited on the supporting member surface by applying surface treatment using water on its surface, on which a convex structure is formed corresponding to a boundary portion of a crystal grain boundary of the supporting member surface is used.

### BACKGROUND OF THE INVENTION

1. Field of the Invention

The present invention relates to an electrophotographic method and a photoreceptor for electrophotography used for the same and, in more particular, an electrophotographic method for performing an image forming based on a background exposure method for scan-exposing a non-image portion (background portion) and a photoreceptor for electrophotography used by the same and, more specifically, to a photoreceptor for electrophotography preferably applicable in an electrophotographic apparatus using a light beam for an exposure light and comprising a light scanning apparatus for scan-exposing such as an electrophotographic apparatus and the like usable in an image forming apparatus such as a printer, a digital copier, facsimile and the like and the electrophotographic method utilizing such a photoreceptor for electrophotography.

2. Related Background Art

In recent years, regarding the electrophotographic apparatus such as a printer, a digital copier, facsimile and the like for performing an image formation based on digitalized information, characteristics such as a good image quality, high-speed printout and the like are attracting more attention than ever. A main stream of the light sources of the electrophotographic system is a laser and LED, and the performance of scanning on a recording medium (photoreceptor for electrophotography) governs the image quality of the printer and the performance of printing speed and the like. In case of using LED as an exposure light source, a combination of spatial arrangement of the light source and an electrical scanning is mainly used. In case of using a laser for the exposure light source, a combination of an optical scanning and the electrical scanning is used.

In the electrophotographic apparatus of the type using a laser as the exposure light source, a light scanning apparatus thereof is, as shown in FIG. 1, constituted by a laser diode 100, a rotary polygon mirror 102, a light source optical system 104 for guiding the laser beam emitted from the laser diode 100 to the rotary polygon mirror 102 and a scanning optical system 108 for guiding the laser beam deflected by the rotary polygon mirror 102 on the recording medium (photoreceptor for electrophotography) 106 and scanning.

An image forming system utilized for the electrophotographic apparatus of digital type is mainly divided into two types relative to an image information and an exposure portion. One is an image exposure method (hereinafter referred to as IAE) for exposing an image portion and the other is a background exposure method (hereinafter referred to as BAE) for exposing the non-image portion.

The BAE is the same as the image forming system used in the electrophotographic apparatus of analogue type, and the member used other than a developing device, a cleaning apparatus, a developer and the like has a merit of being able to be used in common with the electrophotographic apparatus of the analogue type. On the other hand, the IAE is, in order to obtain objective images, required to perform a reversal developing by using a developer of reverse polarity for static latent images formed by an exposure on the photoreceptor for electrophotography.

Although both systems of the BAE method and the IAE method are put into practical use, as to which exposure method should be adapted is much determined by the limitation of the photoreceptor, the developer and the like.

On the other hand, though a transfer separation performance is much governed by transfer efficiency and separation as well as re-transfer latitude, in case of the IAE, since the potential of the non-image portion (background portion) is higher than that of the image portion, the BAE has a higher latitude than that of the IAE.

Since the potential of the photoreceptor will have decayed until it reaches the cleaning apparatus, in case of the IAE using a system for developing by applying the developer to a lower potential portion, a large quantity of developer is easy to remain and adhere on the photoreceptor surface at the part of the cleaning, and regarding a cleaning, the BAE has a wider latitude than that of the IAE.

Regarding the above described development and the cleaning, the technique fostered for a long time by the conventional analogue copier can be easily diverted and, therefore, even in case of the digital type electrophotographic apparatus, selecting the BAE method for an image formation method is much easier for design and, consequently, can provide a stabilized electrophotographic apparatus having a wide latitude. The digital type electrophotographic apparatus which selects the BAE method for the image formation method has, in view of obtaining a good quality image, a merit in that the above described developer remains little in principle and the like and the advantage of providing a high latent potential in the apparatus design and the like.

However, regarding the image formation by the light beam scanning which is the characteristic of the digital type electrophotographic apparatus, in the following points to be described, the BAE rather than the IAE leaves the disadvantage of providing a narrow latitude.

In general, in the image formation technique by the light beam scanning, a size, a shape, a power and the like of a spot of the light beam used for exposure has significant effects on the image quality and stability. In an electrophotograph, by using photocarriers formed by irradiating the light beam on an uniform surface potential distribution formed by charging on the photoreceptor for electrophotography, the surface potential is reduced in the shape of the spot, so that latent images composed of a series of spots reduced in the surface potential are formed. Hence, the quality of the latent images thus formed is greatly affected by the light beam spot shape used for this exposure. In case of the IAE, the light beam is irradiated at a recording image region (black portion) and the developer is adhered on the portion where the surface potential is dropped. Consequently, as compared with a image width, in the case where a half-value width of the above described latent potential distribution is wider, a spread accompanied by this half-value width portion thickens a line width of letters and lines and, in the extreme case, makes them look like crushed. In case of the BAE, the light beam is irradiated at a background portion (non-black portion), which is taken as the portion where the surface potential is dropped and the non-exposure portion is left as the latent image where the surface potential is maintained. The region where the developer is adhered is a region where the surface potential is high, which is this non-exposure portion. For this reason, as compared with the image width, in the case where the half-value width of the latent image potential distribution is high, the line width of letters and lines becomes thin and, in the extreme case, looks like blurred. To avoid this crushing or blurring, even in case of adapting whichever of the IAE or the BAE image forming system, there is an upper limit on the spot diameter and the power of the light beam used for the exposure.

FIG. 2 is a drawing explaining the surface potential differential distribution formed by the exposure of the photoreceptor surface in the IAE and the BAE image forming systems. In the left portion of FIG. 2, a state of one line of the IAE, that is, a state of the light beam being turned on for one line only, and in the right portion of FIG. 2, a state of one line of the BAE, that is, a state of the light beam being turned off for one line only are shown in comparison. ΔV_{L} designates a magnitude of the difference with the surface potential decayed by the exposure in IAE. ΔV_{H} designates a magnitude of the difference with the surface potential decayed by the exposure in BAE. As shown in this FIG. 2, the latitude of the IAE is V_{D}-Vᵢ and the latitude of the BAE is V_{b}-V₂.

As shown in FIG. 2, in case of the BAE, though a series of spot-shaped exposures are superposed, a portion becoming a valley of exposures superposed between adjacent spots is produced. Therefore, in the case where the spot size of the light beam is small or the power thereof is not sufficient for scanning line intervals, a gap of the potential is produced in a light beam irradiation portion with a result that the V₂ becomes high and the latitude becomes small. Accordingly, in case of the BAE method, corresponding to the scanning line intervals, there is a lower limit to the spot size and the power of the light beam. That is, it is known that the latitude of the BAE becomes narrower than that of the IAE in principle.

As described above, in each image forming system, in view of achieving the desired image quality and resolution, it is necessary to set the optimum spot size and the power of the light beam.

(Amorphous Silicon (a-Si) System Photoreceptor)

The image quality obtained in the electrophotograph is, apart from the spot size and the power of the light beam used for the above described exposure, greatly affected by the photoreceptor.

Regarding the photoconductive material forming a photosensitive layer in the photoreceptor, the characteristics such as having high sensitivity, high S/N ratio (photo current(Ip)/dark current(Id)) and an absorption spectrum applicable to the spectrum characteristics of irradiating electromagnetic waves (exposure light), having rapid responsibility to light and desired dark resistance value, being not harmful for human bodies during use and the like are required. Particularly, for the photoreceptors for electrophotography incorporated in the electrophotographic apparatus to be employed as business machines at the office at high frequency, the above described harmlessness during use becomes a still more important item. For the above described each item, there is available amorphous silicon hydride (hereinafter referred to as “a-Si:H”) respectively as a photoconductive material showing an excellent character. For example, as shown in U.S. Pat. No. 4,265,991, the application of the a-Si:H to the photoconductive layer consisting the photosensitive layer of the photoreceptor for electrophotography is described in many publications.

FIG. 3A to FIG. 3D are drawings typically showing the cross-section to explain a plurality of examples relative to the layer structure of the photosensitive layer of the photoreceptor for electrophotography.

In a first example of the layer structure as shown in FIG. 3A, a photoreceptor for electrophotography 400 is constituted by a supporting member 401 where the surface for the photoreceptor shows electroconductivity and, as photosensitive layer 402 disposed on the supporting member 401, a double structure of a photoconductive layer 403 comprising, for example, an a-Si:H,X (non-single crystal having silicon atoms as the base and containing hydrogen or halogen atoms, more preferably amorphous) and having photoconductivity and an amorphous silicon system (amorphous containing at least silicon atoms and carbon atoms (amorphous silicon carbide) or amorphous carbon) surface layer 404.

FIG. 3B is a drawing typically showing a second example in the layer structure of the photosensitive layer constituting the photoreceptor for electrophotography. The photosensitive layer 402 to be disposed on the supporting layer 401 is constituted by, for example, the photoconductive layer 403 comprising, for example, the a-Si:H,X and having photoconductivity and the amorphous silicon system surface layer 404. The photoconductive layer 403 is formed in the upper and lower two layers of a charge generating layer 412 and a charge transporting layer 411.

FIG. 3C is a drawing typically showing a third example in the layer structure of the photosensitive layer constituting the photoreceptor. The photosensitive layer 402 disposed on the supporting member 401 is, for example, composed of an amorphous silicon system charge-injection blocking layer 405, a photoconductive layer 403 comprising a-Si:H,X and having photoconductivity and an amorphous silicon system surface layer 404. The charge-injection blocking layer 405 has a function for blocking the charge-injection from the supporting member 401 to the photoconductive layer 403. Similar to the second example as shown in FIG. 3B, the photoconductive layer 403 is formed in the upper and lower two layers of the charge generating layer 412 and the charge transporting layer 411.

FIG. 3D is a drawing typically showing a fourth example in the layer structure of the photosensitive layer constituting the photoreceptor. The photosensitive layer 402 formed on the supporting member 401 is, for example, constituted by the amorphous charge-injection blocking layer 405, the photoconductive layer 403 comprising the a-Si:H,X and having photoconductivity and an amorphous silicon system upper charge-injection blocking layer 413 and the amorphous silicon system surface layer 404. In this example also, the photoconductive layer is formed in the upper and lower two layers of the charge generating layer 412 and the charge transporting layer 411.

In general, the photoreceptor for electrophotography using the amorphous silicon system such as these a-Si:H and the like utilizes a vapor phase growth method, for example, a film forming method such as a vacuum evaporation method, a sputtering method, an ion plating method, a thermal CVD method, a photo CVD method, a plasma CVD method (hereinafter referred to as “PCVD method”) and the like and heats an electroconductive supporting member to 50° C. to 400° C. and forms an electroconductive layer comprising an a-Si and the like on the supporting member. Among these methods, the PCVD method, that is, a method for decomposing a raw material gas by a direct current discharge or a high frequency wave discharge or a microwave glow discharge and forming the a-Si deposition film is, during the preparation of the photosensitive layer of the photoreceptor, put to practical use as suitable means.

In Japanese Patent Application Laid-Open No. 6-317920, there is disclosed a method of manufacturing a photoreceptor for electrophotography (photosensitive member) comprising a photoconductive layer comprising a non single crystal silicon system material with silicon atoms as the base and an a-C:H surface protection layer having a hydrogen content of 8 to 45 atomic % using a high frequency wave at a frequency not less than 20 MHZ.

Also, in the U.S. Pat. No. 5,939,230, there is disclosed a technique wherein, by disposing layer regions which are different from each other in hydrogen content, optical band gap and characteristic energy at an exponent tail obtained from light absorption spectrum in the photoconductive layer, a photoreceptor highly chargeable in which a temperature property and an optical memory are reduced is obtained.

Further, in Japanese Patent Application Laid-Open No. 57-158650, there is described that, by using for the photoconductive layer an a-Si:H containing hydrogen atoms in 10 to 40 atomic % and having an absorption ratio of two absorption peaks of wave numbers 2100 cm⁻¹ and 2000 cm⁻¹ concerning an infrared absorption spectrum in the range of from 0.2 to 1.7, a highly sensitive and highly resistant photoreceptor for electrophotography can be obtained.

In case of using a substrate made of an aluminum alloy as the supporting member 401 of the photoreceptor, as a corrosion prevention technique, the utilization of means for cleaning the substrate surface by water in which carbon dioxide is dissolved is proposed in U.S. Pat. No. 5,480,754.

Further, there is disclosed a technique, wherein on the photosensitive layer surface, a linear grove with its cross-section in a triangle shape is formed in a peripheral direction and a triangle shaped angle and a pitch of the linear groove are selected within a specified range, whereby improvement of a cleaning ability for the toner of a small grain size is attempted.

By the accumulation of these conventional techniques, electric, optical and photoconductive characteristics which the photoreceptor for electrophotography is in possession and, in addition, the utilization environmental characteristics have been improved, accompanied by which the image quality has also been improved.

Regarding sensitivity, in case of the photoreceptor using the amorphous silicon for the photoconductive layer, since conductivity itself of the photocarriers in the photoconductive layer does not have electric field dependency, in principle, as shown in FIG. 4, in general, an EV characteristic has a linear shape. That is, there is no threshold quantity of light and the like where a change in the quantity of light forming the photocarriers is easily reflected by a change in a surface potential attenuation. Consequently, for example, in correspondence to the quantity of light of Gauss distribution, the surface potential distribution also becomes the Gauss distribution and, therefore, even in the case where the quantity of light distribution tail changes, its advantage is that the impact of a disorder on the developed dot size in the quantity of light distribution tail is relatively small and the influence on the image quality is also reduced. FIG. 4 shows that the exposure distribution of the light beam consisting of a Gaussian distribution is reflected in the potential distribution on the photoreceptor as it is in case that the photosensitive property of the photoreceptor is linear. The left portion of the figure shows the potential distribution of the latent image to the intensity of exposure in a photoreceptor showing the linear EV characteristic. The right portion of the figure shows the potential distribution in case of a light beam having the Gaussian distribution incident upon such a photoreceptor.

The amorphous silicon system material has superior abrasion endurablility and endurablility fluctuation of sensitivity, that is, the EV characteristic is small and there is no problem of sensitivity reduction which is accompanied by abrasion such as OPC using an organic electroconductive material.

However, as described in Japanese Patent Application Laid-Open No. 4-330454, reflectance of crystal grains of the amorphous silicon system material affects light intensity which is virtually incident on the photoconductive layer from among the exposure light irradiated on the surface and, as a result, also affects the image quality itself. In the photoreceptor using the amorphous silicon system material, the grain size and the like of the amorphous silicon system material film is easily affected by the surface of the supporting member during deposition and, even on the photoreceptor surface, the influence of the surface of the supporting member appears and is exerted on the image quality also.

When comparing the BAE system with the IAE system, from the standpoint of transfer separation characteristic and cleaning ability, the electrophotographic method adapting the BAE system is much easier to design and has a resultant advantage of being able to supply a stabilized electrophotographic apparatus having a wide latitude. In this BAE system also, a size, a shape, a power and the like of the spot of the light beam has a significant influence on the image quality and stability.

Recently, to further advance high resolution and high speed of the electrophotographic apparatus, regardless of whichever of the IAE system or the BAE system being used for the exposure system, the spot size of the light beam is made much smaller and highly powerful to increase scanning intensity.

As the spot size of the exposure becomes smaller, the intensity of light virtually incident on the photoconductive layer, from among the exposure light irradiated on the surface, largely depends on the difference in the conditions of the photoreceptor surface on which one spot hits, and consequently, the difference in the conditions of the photoreceptor surface significantly affects the image quality. In particular, as compared with the IAE, in case of the BAE where the exposure is performed on much more surfaces, the influence attributable to the conditions of the photoreceptor surface is reflected on the difference of the image quality and tends to produce, for example, roughness (microscopic dots are dispersed) on the whole of the image quality.

### SUMMARY OF THE INVENTION

The present invention is made in view of the above described problems and, in the electrophotographic method utilizing the digital type electrophotographic apparatus when, with much higher resolution in progress, the spot size of the exposure light is made microscopic, aims to reduce the influence on the image quality attributable to the conditions of the surface of the photoreceptor for electrophotography and provide a method capable of providing output images of high resolution and much sharper high quality of the images and a new photoreceptor for electrophotography utilized in such an electrophotographic method. More specifically, in order to further proceed with high speed and high resolution by utilizing the electrophotographic apparatus adapting the BAE system when the spot size of the exposure light is made microscopic and highly powerful, the present invention aims to provide a photoreceptor for electrophotography having the conditions of the surface suitable for reducing the influence on the image quality attributable to the conditions of the photoreceptor for electrophotography.

According to an aspect of the present invention, there is provided an electrophotographic method in which an electrophotographic apparatus comprising a photoreceptor for electrophotography, an image forming light irradiation means and a developing means is used and a step of forming an image is comprised, the step of forming an image comprising the steps of forming a static latent image on the photoreceptor by the image forming light irradiation means based on a background exposure method for scan-exposing a non-image portion comprised of a background portion and visualizing the static latent image by the developing means, wherein the photoreceptor comprises a supporting member and a photosensitive layer, which supporting member is comprised of aluminum or an aluminum alloy and has a surface being subjected to a surface treatment using water before forming the photosensitive layer and exposing aluminum crystal grain boundaries thereon, and which photosensitive layer is formed on the supporting member, contains amorphous silicon and has a surface exposing thereon crystal grain boundaries corresponding to the aluminum crystal grain boundaries on the supporting member surface; and an average grain size of crystal grains represented by the crystal grain boundaries exposed on the photosensitive layer surface is larger than a diameter of a spot of a light beam for exposure of the image forming light irradiation means which diameter is a spot width equal to 1/e² of a peak intensity; and convex portions corresponding to the crystal grain boundaries exposed on the photosensitive layer surface are disposed on the photosensitive layer surface.

In the above electrophotographic method, a height of the convex portion may be set within the range of not less than 0.05 μm and not more than 0.4 μm.

In the above electrophotographic method, aluminum grains represented by the aluminum crystal grain boundaries exposed on the supporting member may have an average grain size larger than the diameter of the spot of the light beam for exposure.

According to another aspect of the present invention, there is provided a photoreceptor for electrophotography comprising a supporting member comprising aluminum or an aluminum alloy and a photosensitive layer containing amorphous silicon and being formed on the supporting member, wherein the supporting member has a surface subjected to a surface treatment using water; convex portions are formed on a surface of the photosensitive layer, corresponding to crystal grain boundaries of aluminum exposed on the supporting member surface; and a height of the convex portions is set within the range of not less than 0.05 μm and not more than 0.4 μm.

In the above photoreceptor for electrophotography, the surface treatment using water may include a treatment using a treatment liquid comprising a detergent dissolved into water having a resistivity of 1 MΩ·cm (25° C.).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a drawing showing one example of a light scanning apparatus structure;

FIG. 2 is a drawing typically showing a surface potential in a latent image of each one line when using IAE system and BAE system as an exposure system and a graph showing relations among a exposure distribution, a photoreceptor EV characteristic and a potential distribution;

FIGS. 3A, 3B, 3C and 3D are layers showing one example of the layer structure of a photosensitive layer used in an photoreceptor for electrophotography;

FIG. 4 is a drawing typically showing the potential distribution of a latent image in the photoreceptor showing a linear EV characteristic for the exposure light where light intensity shows a Gauss distribution;

FIG. 5 is a drawing showing one example of an observed image of the convex structure of the boundary portion of a crystal grain boundary on the photosensitive layer surface by AFM;

FIG. 6 is a drawing showing one example of a deposition film forming apparatus of RF-PCVD method;

FIG. 7 is a drawing showing one example of the deposition film forming apparatus of VHF-PCVD method; and

FIG. 8 is a typical schematic diagram for explaining one example of the procedure of an image forming process.

### DETAILED DESCRIPTION OF THE PREFERRED EMBODIMENTS

In order to solve the above described problems, the present inventors conducted various studies and as a result it was found that, with respect to the photoreceptor using the amorphous silicon system material, the boundary with each of a plurality of crystal grains constituting the amorphous silicon system material film to be used is exposed on the photosensitive layer surface, and this crystal grain boundary and the crystal grain surface are different in optical and electrical characteristics, and specifically, when the exposure light is irradiated, with respect to the crystal grain boundary and the crystal grain surface, a difference arises in the attenuation of the surface potential by the formed photocarriers. Further, it was found that when the average grain size of the crystal grains is made large as compared with the spot size of the exposure light in the photosensitive layer surface, the influence attributable to the difference of the optical and the electrical characteristics between the above described crystal grain boundary and crystal grain surface is greatly controlled, so that a good image quality can be obtained.

In addition, when the amorphous silicon system material film to be used is deposited, the size of the crystal grains exposed on the photosensitive layer surface reflects the conditions of the supporting member surface which becomes a substrate, and even in the electroconductive material constituting the supporting member surface, the crystal grains are exposed on the surface. When the average grain size of the crystal grains is made larger than the spot size of the exposure light, the crystal grains exposed on the photosensitivity layer surface comprising the amorphous silicon system material film deposited there can be also made larger in the average grain size than the spot size of the exposure light with high repeatability.

Based on such knowledge, various experimental studies were further conducted and as a result there was obtained the findings as follows. Regarding the photoreceptor for electrophotography, in general, the shape of the supporting member is taken as cylindrical, and when aluminum or an aluminum alloy is used as the electroconductive material constituting the same, the supporting member surface comprising the crystal grains uniformalized in the grain size can be easily obtained. Before the amorphous silicon system material film is deposited on this surface, the surface treatment using water is applied to it, so that in correspondence to the crystal grains exposed on the supporting member surface, the crystal grains exposed on the photosensitive layer surface can be uniformalized in the average grain size and peeling of the substrate member surface from the amorphous silicon system material film to be deposited was also confirmed to be controlled. When the amorphous silicon system material film is deposited on the supporting member made of aluminum or an aluminum alloy which was applied with the surface treatment using water, the crystal grains exposed on the photosensitive layer surface are uniformalized in the average grain size, while on the other hand, in correspondence to the crystal grain boundary, the convex structure is formed, and when such light receiving material comprising the convex structure is used, it becomes compatible with high resolution, so that excellent images can be obtained. Such was the findings which have accomplished the present invention.

In addition, regarding the relation between the height of the convex structure formed on this photosensitive layer surface and the image quality to be obtained, further studies were conducted and as a result it was found that, in case of the electrophotographic apparatus using the BAE system, when the convex structure whose height is within the range of 0.05 to 0.4 μm is used, much better image quality can be obtained, which is a suitable condition for the electrophotographic method of the BAE system.

That is, the electrophotographic method of the present invention is an method, wherein by using at least the photoreceptor for electrophotography, the image forming light irradiation means and the electrophotographic apparatus provided with developing means and, based on the background exposure method for scan-exposing the non image portion (background portion), by using the above described image forming light irradiation means, the static latent images are formed on the above described photoreceptor for electrophotography and by visualizing the above described static latent images the electrophotographs are fabricated, and wherein the photoreceptor for electrophotography to be used in the above described electrophotographic apparatus is an photoreceptor for electrophotography comprising the supporting member comprising aluminum or an aluminum alloy and the photosensitive layer containing amorphous silicon formed on the above described supporting member and, for the above described supporting member, before the above described photosensitive layer containing amorphous silicon is formed, the supporting member comprising the surface applied with the surface treatment using water is employed and in correspondence to the crystal grain boundary of aluminum exposed on the above described supporting member surface the average grain size of the crystal grain boundary exposed on the above described photosensitive layer surface is larger than the exposure light beam spot size (spot width equal to 1/e² of peak intensity) of the above described image forming light irradiation means, and in correspondence to the crystal grain boundary exposed on the above described photosensitive layer surface, the convex portion is disposed on the surface of the above described photosensitive layer containing amorphous silicon. Preferably, in correspondence to the crystal grain boundary of aluminum exposed on the above described supporting member which is applied with the surface which uses water, the height of the convex portion disposed on the surface of the above described photosensitive layer containing amorphous silicon is selected within the range of not less than 0.05 μm and not more than 0.4 μm.

The electrophotographic method of the present invention is preferable to be taken as an electrophotographic method, wherein the light beam is used for the above described exposure by the image forming light irradiation means and by comparing the spot size (spot width equal to 1/e² of peak intensity) of the above described light beam exposing the above described photoreceptor for electrophotography surface with the average crystal grain size of aluminum exposed on the above described supporting member surface, the supporting member comprising aluminum or an aluminum alloy where the above described average crystal grain size becomes larger than the spot size of the above described light beam is employed. Incidentally, the electrophotographic method of the present invention uses the light beam for the above described exposure by the image forming light irradiation means, and the above described light beam is preferably taken as a laser beam.

For example, it is preferable that the above described surface treatment using water for the supporting member of the photoreceptor for electrophotography used in the electrophotographic method of the present invention contains a treatment using a treatment liquid comprising detergent dissolved into water having resistivity of not less than 1 MΩ·cm (25° C.).

In addition, it is desirable that the photoreceptor for electrophotography of the present invention exclusively used for the above described electrophotographic method of the present invention is an photoreceptor for electrophotography comprising the supporting member comprising at least aluminum or an aluminum alloy and the photosensitive layer containing amorphous silicon disposed on the above described supporting member, wherein the above described supporting member is an supporting member comprising the surface applied with the surface treatment using water and, in correspondence to the crystal grain boundary of aluminum exposed on the above described supporting member surface applied with the surface treatment using water, the convex portion is formed on the surface of the above described photosensitive layer containing amorphous silicon, and the height of the above described convex portion is selected within the range of not less than 0.05 μm and not more than 0.4 μm.

Further, the above described surface treatment using water for the supporting member is suitably performed by using the treatment liquid comprising detergent dissolved into water having resistivity of not less than 1 MΩ·cm (25° C.).

In addition, by using the above described electrophotographic method of the present invention, the present invention also provides an electrophotographic apparatus, which is specifically an electrophotographic apparatus comprising at least the photoreceptor for electrophotography, the image forming light irradiation means and the developing means, and based on the background exposure method for scan-exposing the non-image portion(background portion) and by using the above described image forming light irradiation means, forms the static latent images on the above described photoreceptor for electrophotography and uses a system for fabricating the electrophotographs by visualizing the above described static latent images by the above described developing means, and which is an photoreceptor for electrophotography comprising the supporting member comprising aluminum or an aluminum alloy and the photosensitive layer containing amorphous silicon as the above described photoreceptor for electrophotography, and wherein before the above described photosensitive layer containing amorphous silicon is formed, for the above described supporting member, the supporting member comprising the surface applied with the surface treatment using water is employed and, in correspondence to the crystal grain boundary of aluminum exposed on the above described supporting member surface, the photoreceptor for electrophotography in which the convex portion is disposed on the above described photosensitive layer surface containing amorphous silicon is provided.

That is, the electrophotographic apparatus constituted by using the above described photoreceptor for electrography of the present invention can suitably use the background exposure method for scan-exposing the non-image portion (background portion) as the image forming system.

Needless to mention, in the present invention, these can be suitably combined based on the above configuration, which can be changed within the scope of the present invention as occasion demands.

In the photoreceptor using amorphous silicon for the photosensitive layer, the grain size and the like of amorphous silicon system material film and the like are easily affected by the supporting member during deposition. In the present invention, by utilizing this phenomenon, the surface treatment using water in advance is applied to the supporting member comprising aluminum used for the photoreceptor or an aluminum alloy, and by this surface treatment, the supporting member surface is kept modified. By forming the photosensitive layer on this surface, an amorphous silicon system material film of the crystal grain size corresponding to the crystal grain size of the above described aluminum or an aluminum alloy is formed with good repeatability. Although, in the supporting surface, the conditions vary with respect to the crystal grain surface and the crystal grain boundary, by using the above described surface treatment using water, the difference itself of the surface conditions can be made highly repeatable.

Consequently, thereafter, when the photosensitive layer is deposited, in the boundary portion of the crystal grain surface and the crystal grain boundary, there is created the difference in the film thickness of a deposited film and, in correspondence to the crystal grain boundary and the boundary portion, a convex structure can be formed with high repeatability. Although the height of the convex portion of the convex structure to be formed corresponding to the crystal grain boundary and the boundary portion depends on the film thickness of the whole of the photosensitive layer, by controlling the surface treatment condition using water, a modification degree of the supporting member surface can be controlled and as a result the height of the convex portion can also be fairly controlled. By using the above described means, the average grain size of the crystal grain surface of the photoreceptor surface and the height of the convex portion can be set within a desired range, respectively.

The boundary attributable to the crystal grain boundary of the supporting member, which appears on this photoreceptor, is considered to be different from a flat crystal grain surface with respect to optical and electrical characteristics. Therefore, if the spot of the light beam which scan-exposes the photoreceptor surface happens to be incident on the boundary line of this crystal grain boundary, the potential decrease of one spot portion is different from the other. In the image formation, though the image formation such as one spot image or one line image is infrequent but not rare, in many cases, images are formed adjacently and composed of a plurality of spots and lines (line portion) and hence it is extremely rare that the light beam is incident only on the boundary portion and, in the majority of cases, the light beams of several spots are incident on the whole place including the boundary portion. Further, the adoption of the background exposure method further reduces a possibility of one spot exposure and one line exposure and makes it almost inevitable for the light beams of several spots to be incident on the whole place including the boundary portion.

In such circumstances, if the average grain size of the crystal grain surface of the photoreceptor surface is made larger than the spot size of the light beam which performs scan-exposing, an adjacent spot of the light beam incident on the boundary portion is inevitably incident on the inside of the crystal grain boundary instead of the boundary portion and a slight potential fluctuation of one spot of the boundary portion is superposed on a plurality of spots adjacent to the neighborhood and uniformalized and as a result alleviated to such an extent that it can be substantially ignored. Hence, no deterioration of the image quality is caused.

In the photoreceptor for electrophotography of the present invention, the crystal grain surface of the photoreceptor surface corresponding to the crystal grain boundary is arranged to be obtained for the above purpose and at the same time, in correspondence to the boundary portion of the crystal grain boundary, the convex structure is formed with high repeatability. Contrary to the case where the above described exposure spot comes to the boundary portion, when the boundary portion happens to come between the spot and the spot of the BAE system, a drop of potential of the boundary portion is slightly smaller than that of the flat crystal grain surface and the degree thereof differs depending on the height of the convex structure. As the height of the convex structure exceeds 0.4 μm and becomes much higher, a fog gradually becomes larger, thereby affecting the image quality. On the other hand, if the height of the convex structure does not satisfy 0.05 μm, a separative latitude tends to drop also.

Although depending on the film thickness of the whole of the photosensitive layer, in order to maintain the separative latitude much higher, it is most efficient that the height of the convex structure is controlled to about 0.2 μm, and in order to more efficiently eliminate the above described fog, the height of the convex structure is controlled within the range of not less than 0.05 μm and not more than 0.4 μm, thereby making the effect of the present invention reliable.

Hereinafter, the photoreceptor for electrophotography of the present invention and the electrophotographic method utilizing the same will be described more in detail.

(Layer Structure of Photosensitive layer)

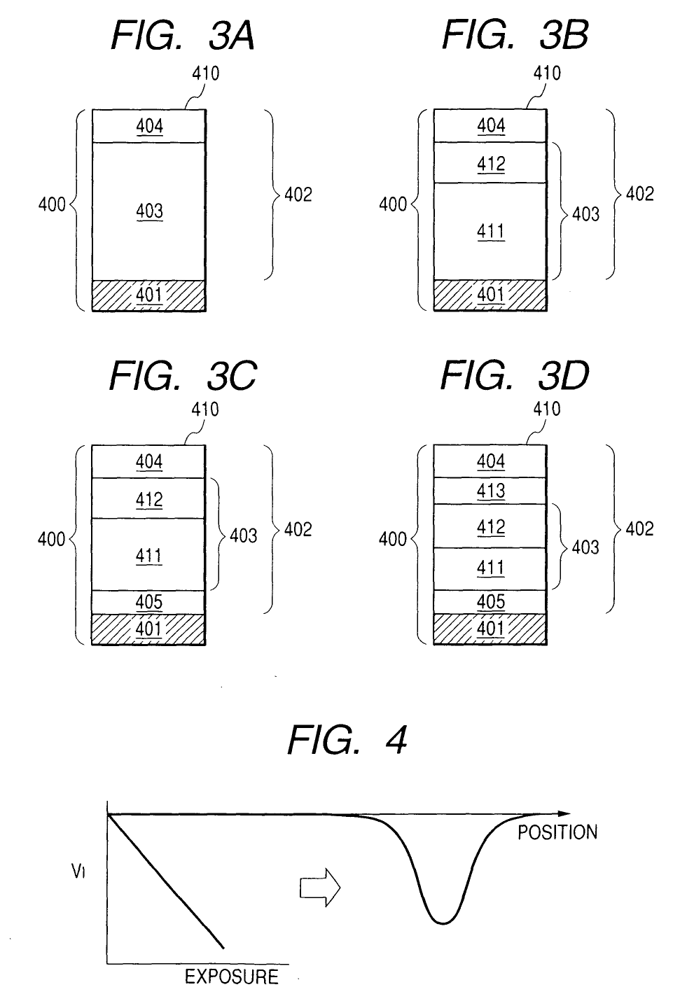

A photoreceptor for electrophotography of the present invention comprises a supporting member comprising at least aluminum or an aluminum alloy and a photosensitive layer containing amorphous silicon disposed on the above described supporting member. This photosensitive layer can take various layer structures which are also utilized in the conventional photoreceptor and one example of the structure will be shown in FIGS. 3A to 3D.

That is, four types of the layer structures as shown in FIGS. 3A to 3D are suitably applicable to the photosensitive layer containing amorphous silicon in the photoreceptor for electrophotography of the present invention, respectively. Although these layer structures were previously explained by using the same drawings, they will be described again as one suitable example of the photoreceptor of the present invention.

In a first example of the layer structure of the photosensitive layer as shown in FIG. 3A, the photoreceptor for electrophotography 400 is constituted by a supporting member 401 and, as a photosensitive layer 402 disposed on the supporting member 401, a double structure of a photoconductive layer 403 having photoconductivity and a surface layer 404.

In a second example of the layer structure of the photosensitive layer as shown in FIG. 3B, the photosensitive layer 402 disposed on the supporting member 401 is constituted by the photoconductive layer 403 having electroconductivity and the surface layer 404. The photoconductive layer 403 is formed in the upper and lower two layers of the charge generating layer 412 and the charge transporting layer 411.

In a third example of the layer structure of the photosensitive layer as shown in FIG. 3C, the photosensitive layer 402 disposed on the supporting layer 401 is constituted by a charge-injection blocking layer 405, the photoconductive layer 403 having photoconductivity and the surface layer 404. The charge-injection blocking layer 405 has a function for preventing the charge injection from the supporting member 401 to the photoconductive layer 403. Similar to the second example as shown in FIG. 3B, the photoconductive layer 403 is formed in the upper and lower two layers of the charge generating layer 412 and the charge transporting layer 411.

In a fourth example of the layer structure of the photosensitive layer as shown in FIG. 3D, the photosensitive layer 402 disposed on the supporting member 401 is constituted by the charge-injection blocking layer 405, the photoconductive layer 403 having photoconductivity, an upper charge-injection blocking layer 413 and the surface layer 404. In this example also, the photoconductive layer is formed in the upper and lower two layers of the charge generating layer 412 and the charge transporting layer 411.

Usually, in order to maintain the potential of the surface which is charged, the photoconductive layer to be used in the photoreceptor for electrophotography of the present invention disposes the surface layer 404 in addition to the photoconductive layer 403 where the absorption of the exposure light occurs. Also, it is preferable that the charge-injection blocking layer 405 is disposed between the photoconductive layer 403 and the supporting layer 401.

Hereinafter, the supporting member and the photosensitive layer constituting the photoreceptor for electrophotography of the present invention will be described in detail.

(Supporting Member)

If the supporting member to be used in the photoreceptor for electrophotography of the present invention is an supporting member comprising aluminum or an aluminum alloy as its base, both of them can be utilized. In case of using the supporting member comprising the aluminum alloy, if the supporting member containing aluminum as its chief ingredient and using alloy comprising either silicon or magnesium or both of them, the effect of the present invention will become remarkable and much preferable.

Specifically, employing the supporting member which uses Al—Mg alloy of No. 5000 series of JIS regulation, Al—Mg alloy of high purity aluminum material of 1N99, 1N90 and so forth externally added with magnesium and the like are much preferable.

Since the photoreceptor for electrophotography of the present invention is usually utilized in the mode of a photosensitive drum in the electrophotographic apparatus, the shape of the supporting member 401 is taken as cylindrical.

In the photoreceptor for electrophotography of the present invention, the crystal grain size of the supporting member surface comprising aluminum or an aluminum alloy is preferably made larger in its average grain size than the spot size of the light beam used in the exposure. Consequently, the size of the crystal grain constituting aluminum or an aluminum alloy is required to be controlled within a specific range.

In the aluminum or the aluminum alloy, the method of controlling its crystal grain size can use any method as long as the distribution of its grain size is uniformalized, which is applicable for the fabrication of the supporting member to be used in the photoreceptor for the electrophotography of the present invention.

For example, the method described in U.S. Pat. No. 4,686,165 and explained as follows is applicable.

In the step of solidifying aluminum or an aluminum alloy from its molten state, the molten metal is subjected to irradiation of an ultrasonic wave. Minimizing the size of the crystal grains is achieved by the destroying action and the cavitation action owing to the frictional force working between the crystal grains and the melting liquid, so that an uniform grain size distribution can be obtained.

The aluminum or the aluminum alloy is subjected to annealing which is performed by heating the metal for an extended period of time at a temperature immediately below the solidus line to reduce the size of large crystal grains, and at the same time to diffuse the components to uniformalize the grain average distribution and the composition.

Cooling is performed so as to pass through the temperature region at an appropriate cooling rate in which the shifting of the phase takes place, so that the development of nuclei from the molten liquid as well as the subsequent growth rate of the crystal particles can be controlled and as a result the crystal grains to be obtained are controlled and uniformalized. In general, as the cooling temperature becomes faster, there arises a shortage of supply of solute atoms, causing a delay of growth of new phases and as a result the grain size of the crystal composition can be limited and controlled within a specific range to be uniformalized.

By using either of the above described methods, attempt can be made to control and uniformalize the average particle size of the crystal grains, and the average particle size of the crystal grains in the supporting member comprising aluminum or an aluminum alloy to be exposed on the surface can be controlled to be larger than the spot size of the light beam.

Corresponding to the spot size of the light beam to be used in the exposure light, the average particle size of the crystal grains is suitably selected to be larger than the spot size of the light beam and, nevertheless, as compared with the spot size of the light beam, to be within the range of a size not unnecessarily to be large. For example, in case of obtaining an image having a resolution of not less than 600 dpi, it is preferable that, in the supporting member comprising aluminum or an aluminum alloy, the particle size distribution of its crystal grains is selected within the range of about 60 to 120 μm.

As a method for forming the convex structure corresponding to the boundary portion of the crystal grain boundary on the surface of the photosensitive layer deposited on the supporting member in which the crystal grains having the adequate average particle size is exposed on its surface and controlling its height of the convex portion, the present invention uses a method for performing the surface treatment using water for the supporting member surface comprising aluminum or an aluminum alloy.

It is preferable that the water to be used for this surface treatment is water having its own resistivity of not less than 1 MΩ·cm (25° C.). If water having the resistivity not satisfying 1 MΩ·cm (25° C.), that is, water significantly containing electrolyte showing ion conductivity is used, its resistivity falls down, and at the same time the controllability of the height of the convex structure tends to deteriorate. Incidentally, the surface treatment can be performed also by using a solution which dissolves detergent into water having a resistivity of not less than 1 MΩ·cm (25° C.). This detergent not only improves wettability between the water and the supporting member surface and makes it possible to perform a uniform surface treatment, but also plays a role of expediting the elimination of impurities and minute dust adhered on the surface, thereby performing much suitable surface treatment.

In the surface treatment, the temperature of water is selected between 10° C. to 90° C. and controlled to the temperature selected according to the size of the crystal grains, so that the height of the convex structure can be controlled. In general, in case of making the height of the convex structure higher, raising the temperature is effective.

Incidentally, in the case where the crystal grains are small, the temperature of water is set higher than the above described range and as the duration of the surface treatment time is prolonged, probably for the reason that the supporting member surface subjected to an excessive surface treatment becomes remarkably rough, the formation of the convex structure is rather decreased, thereby gradually increasing such an inconvenience where there arises peeling of the deposited film and an increase of surface defects. On the contrary, in the case where the temperature is too low, the progress of the surface treatment is slow, and in addition, cleaning effect is also reduced, so that the removal of deposits is not sufficient and as a result, in the amorphous silicon film of the photosensitive layer subsequently deposited, there sometimes arises the surface defects. Accordingly, the surface treatment using water having high resistivity or the water in which detergent is dissolved is performed by selecting its liquid temperature within the above described temperature range, while controlling an adequate temperature for removing impurities and deposits and for cleaning, so that the surface defects of the amorphous silicon film and the film peeling can be prevented.

Subsequent to the surface treatment using the water having high resistivity or the water in which detergent is dissolved, if an additional surface treatment containing carbon dioxide is performed as a second surface treatment, it is more effective to control the height of the convex structure.

As the water containing carbon dioxide used for this second surface treatment, is employed a liquid in which a predetermined amount of carbon dioxide is dissolved into the above described water having high resistivity. The dissolved amount of carbon dioxide shall be not more than 60% of a saturated dissolved amount, and controlling the amount to be obtained within the range of not less than 3.8 and not more than 6.0 in terms of pH or not less than 2 μS/cm and not more than 40 μS/cm in terms of conductivity is more preferable for controlling the height of the convex structure on the photosensitive layer formed by surface treatment using water. Increasing the dissolved amount of carbon dioxide or raising water temperature during the surface treatment can make the height of the convex structure high. However, if the dissolved amount of carbon dioxide is too much, bubbles tend to be generated due to fluctuation (rise) of the water temperature, and on the supporting member surface, treatment irregularities due to adherence of the generated minute bubbles tend to be produced. Further, if the dissolved amount of carbon dioxide is much, the pH of liquid to be obtained is reduced, so that the damages such as a hole and the like are sometimes caused to the supporting member surface.

As described above, two steps of the surface treatment are performed, and in the first step of the surface treatment using water, a water temperature and resistivity are checked, and in the second step of the surface treatment using the water containing carbon dioxide, a liquid temperature and a carbon dioxide dissolved amount are controlled, and in addition, by adequately selecting the surface treatment time of each step, an amorphous silicon film is deposited on the supporting member surface which is subjected to the surface treatment, so that in correspondence to the boundary portion of the crystal grain boundary of the supporting surface the repeatability of the convex structure can be formed and also the height of the convex structure thus formed can be controlled within a desired range with high repeatability.

According to the examinations conducted by the present inventors, the crystal grain surface and the crystal grain boundary exposed on the supporting member surface comprising aluminum or aluminum alloy differ in its structure from a microscopic view. With this fact taken into consideration, if the above described surface treatment using water is performed, though some modification of the surface conditions is brought about, with respect to the crystal grain surface and the boundary portion of the crystal grain boundary, the surface conditions such as the degree of the modification and the like become different. Accordingly, reflecting the difference in the surface conditions, even for the deposited amorphous silicon film, the difference is caused to its microscopic inner structure also to form the convex structure, and its height is considered to be controlled according to the degree of modification by the surface treatment.

Although applying the surface treatment using water to the supporting member surface can control the height of the convex structure, as far as the supporting member surface applied with the surface treatment is observed, there is confirmed no convex structure on the surface. Accordingly, the above described difference of the surface conditions is considered to be the difference of the surface properties of several atomic layers level. For example, by bringing into contact with the water having high resistivity, the oxide coat layer formed on the surface differs in its thickness with respect to the crystal grain surface and the boundary portion of the crystal grain boundary, and then, carbon dioxide is included and the oxide coat layer is liquated in the water, but in the boundary portion between the crystal grain surface and the crystal grain boundary, the difference of oxide coat layer thickness of several atomic layers level finally remains as the surface conditions and the like, which is considered as its mechanism.

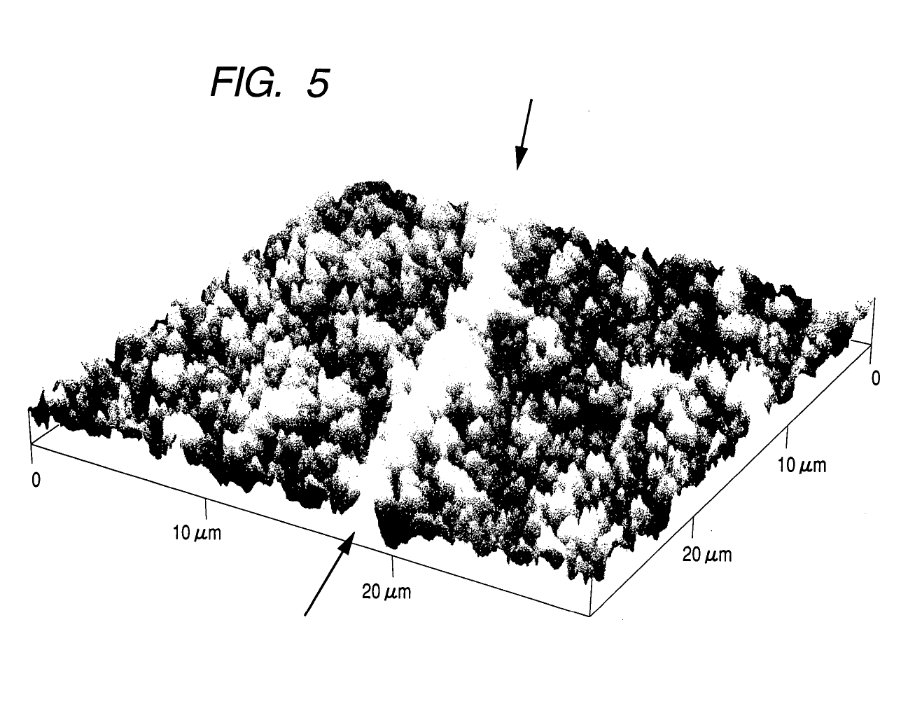

In this way, after the surface treatment is performed, the boundary portion of the crystal grain boundary existing in the supporting member surface is modified to the surface conditions which are different from the inside of the crystal grain boundary and as a result, thereafter, on the surface of the amorphous silicon film deposited on the surface also, the convex structure corresponding to the boundary portion of the crystal grain boundary is created. In the electrophotographic method of the present invention, the height of the convex portion which is within the range of not less than 0.05 μm and not more than 0.4 μm is suitably utilized. An analysis of the height of this convex structure can be made by, for example, a real time scanning type laser microscope (1LM21D produced by Lasertec) or an atomic force microscope AFM (Qscope 250 produced by QUESANT). Shown in FIG. 5 is one example of the image in which the convex structure (portion indicated by an arrow) formed on the photosensitive layer corresponding to the boundary portion of the crystal grain boundary of the supporting member surface was observed by the AFM.

It should be noted that, for the measurement of the crystal grain boundary, a MEAUSRING MICROSCOPE (STM-UM) produced by OLYMPUS was used. Regarding the average size of the crystal grain boundary, an observation region was randomly selected on the supporting member surface and the crystal grains found within the observation region were measured in the breadth of the crystal grains, thereby calculating an average value.

(Photosensitive Layer)

In a photoreceptor for electrophotography according to the present invention, on a supporting member 401 subjected to the above described treatment, a photosensitive layer 402, for example, prepared by deposition of an amorphous silicon-based material film with a stratified structure exemplified in FIG. 3A to FIG. 3D is formed. For formation of the photosensitive layer 402, as a rule, vapor deposition method, for example, film forming methods of vacuum evaporation method, spattering method, ion plating method, thermal CVD method, photo CVD method, and plasma CVD method (hereafter, “PCVD method”) can be used. However, the plasma CVD method is more preferably used.

(Photoconductive Layer)

In the electrophotographic light receiving member according to the present invention, the photoconductive layer 403, which is an essential component element of the photosensitive layer 402, is required for deposition of a predetermined film thickness by e.g. a plasma CVD method. In the plasma CVD method, each proper value is selected with respect to film-forming parameters, i.e. a flow rate of a gas as a material, a temperature of the supporting member, a pressure and a high frequency electric power supply in order to yield a desired characteristic. Specifically, it is preferable that it is formed by using the plasma CVD method, namely, glow discharge method (an alternate current CVD method such as low frequency CVD method, high frequency CVD method or microwave CVD method; direct current CVD method or the like), by vacuum deposition method to decompose the material gas. In fabricating the photoconductive layer having the desired characteristic, among plasma CVD methods, the high frequency glow discharge using a high frequency power of an RF band is more preferable because of relatively easy control of film preparation condition.

In forming the photoconductive layer 403, by the high frequency glow discharge method, for example, basically, the material gas for Si supply capable of supplying a silicon atom (Si) and the material gas for H supply capable of supplying a hydrogen atom (H) or/and the material gas for X supply capable of supplying a halogen atom (X) is led together with a dilution gas and the like in a desired flow rate to a reaction container capable of reducing to a desired pressure, the pressure inside the above described reaction container is reduced to the predetermined one and also high frequency power is introduced to generate glow discharge finally resulting in deposition of the amorphous silicon film containing the hydrogen atom or/and halogen atom on the supporting member 401 arranged in a predetermined position in the reaction container, which has been previously heated to a predetermined temperature.

In addition, in the photoreceptor for electrophotography according to the present invention, the photoconductive layer 403 uses amorphous silicon (hereafter, a-Si:H, X) containing hydrogen atom (H) or/and a halogen atom. The hydrogen atom or/and the halogen atom contained therein compensates an unused valence of the silicon atom in amorphous silicon and achieves a quality of the amorphous silicon film required for the photoconductive layer; specifically, improves photoconductivity and an electric charge-holding property. Therefore, a content of hydrogen atoms or a sum of contents of hydrogen atoms and halogen atoms is preferably selected from a range from 10 to 40 atom percents to a total sum of silicon atoms and hydrogen atoms or/and the halogen atoms.

In the photoreceptor for electrophotography according to the present invention, as the silicon supply gas used for deposition of the a-Si:H, X film of the photoconductive layer 403, silicon hydrogenated (silanes) such as SiH₄, Si₂H₆, Si₃H₈, and Si₄H₁₀, which are in gas state in a room temperature, and those gasifiable by vaporization by heating is an example of an Si-containing substance. In addition, in consideration of readiness of handling in film formation and better Si supply efficiency, SiH₄ and Si₂H₆ are more preferable.

In the a-Si:H, X film of the photoconductive layer 403, in order to introduce structurally the hydrogen atom, control content of the hydrogen atom, and achieve the objective film property, it can be used as ready control method that as the material gas for H supply, H₂ and/or He further mixed in a predetermined volume, or the material gas for the above described Si supply is further mixed with a predetermined volume of gas of silicon compound containing other hydrogen atoms to form the a-Si:H, X film. In applying this method, each gas of the material gas for Si supply and the material gas for H supply can use a single species and also use a mixture of a plurality of gas species in a predetermined mixing proportion.

As the material gas for supplying the halogen atom used for deposition of the a-Si:H, X film, for example, gaseous or gasifiable halogen-containing compounds, for example, halogen gas, halide compound, halogen-halogen compound containing the target halogen, silane derivatives substituted by a halogen and the like are exemplified as preferable material substances. In addition to these, gaseous or gasifiable halogen atom-containing hydrogenated silicon compounds, of which composition element is the silicon atom, halogen atom, and hydrogen atom, can be also exemplified as the preferable material substance. As halogen-containing compounds more preferably usable, specifically, halogen-halogen compound containing fluorine, such as fluorine gas (F₂), BrF, ClF, ClF₃, BrF₃, BrF₅, IF₃, IF₇ and the like can be exemplified. In addition, among silicon compounds containing the halogen atom or silane derivatives substituted by the halogen atom, silicon compounds containing the a fluorine atom or silane derivatives substituted by the fluorine atom is more preferable; silicon fluoride such as SiF₄, Si₂F₆ and the like can be exemplified as more preferable example.

Content of the hydrogen atom or/and halogen atom contained in the a-Si:H, X film of the photoconductive layer 403 can be controlled to a desired range by controlling such as the temperature of the supporting member 401, supply of material gas for the hydrogen atom or/and halogen atom to be led to the reaction container, and a discharge electric power.

In the photoreceptor for electrophotography according to the present invention, the a-Si:H, X film of the photoconductive layer 403 can be received the atom to control conductivity thereof and in addition, content of the atom controlling conductivity may be distributed in a thickness direction of the film.

As the atom introduced to the a-Si:H, X film to control conductivity thereof, impurity atom so-called in a semiconductor field is used. Specifically, in order to yield a p-type conductive property, the atom (hereafter, IIIb group atom) belonging to IIIb group (13 group) of the periodic table and to yield n-type conductive property, the atom (hereafter, Vb group atom) belonging to Vb group (15 group) of the periodic table are preferably used. As usable Vb group atom, specifically, boron (B), aluminum (Al), gallium (Ga), Indium (In), thallium (Ti) and the like are exemplified and use of B, Al, and Ga are more preferable. As usable Vb group atom, specifically, P (phosphorus), As (arsenite), Sb (antimony), Bi (bismuth) and the like are exemplified and P and As are more preferably used.

Content of atoms, contained in the a-Si:H, X film of the photoconductive layer 403 and controlling conductivity is selected from ranges from 5×10⁻³ to 50 atom ppm; preferably, 1×10⁻² to 30 atom ppm; more preferably, 5×10⁻² to 20 atom ppm. Distribution of concentration of atoms to control conductivity can be made to an even concentration in the film or, the concentration can be distributed in the thickness direction of the film to make, for example, distribution to reduce concentration from the supporting member side to a surface side. In other words, as exemplifying the photoconductive layer 403 in FIG. 3C and FIG. 3D, a doubled layer made from an upper charge generating layer 412 and a lower charge transporting layer 411 is constituted. The constitution can be that in the charge generating layer 412 in the surface side, concentration atoms to control conductivity is decreased and in the charge transporting layer 411 of the supporting member side, concentration atoms to control conductivity is increased.

In the case where the atom controlling conductivity, specifically, the atom of the IIIb group, is structurally introduced, in forming the deposition film, in the reaction container, together with other material gases used for deposition of the a-Si:H, X film, the material substance for introduction of the atom of the IIIb group may be introduced in the gaseous state. As the material substance for introduction of the atom of the IIIb group, use of the compound containing the atom of the IIIb group, which is in the gaseous state in the room temperature and ordinary pressure or at least gasifiable readily under the condition of deposition film formation, is preferable.

Specifically, as the material substance for introduction of the atom of the IIIb group, for example, as the material substance for introduction of a boron atom, hydrogenated boron such as B₂H₆, B₄H₁₀, B₅H₉, B₅H₁₁, B₆H₁₀, B₆H₁₂, B₆H₁₄ and the like and halogenated boron such as BF₃, BCl₃, BBr₃ and the like can be exemplified. In addition to these, as other material substances for introduction of the atom of the IIIb group, for example, halogenated compounds such as AlCl₃, GaCl₃, Ga(CH₃)₃, InCl₃, TlCl₃ and the like and organometallic alkyl compounds can be exemplified as examples of substances preferably usable.

On the other hand, specifically, as the material substance for introduction of the atom of the Vb group, hydrogenated phosphorus such as PH₃, P₂H₄ and the like, PH₄I, and halogenated compounds of phosphorus such as PF₃, PF₅, PCl₃, PCl₅, PBr₃, PBr₅, PI₃ and the like are exemplified. In addition, as the material substance for introduction of the atom of the Vb group, halogenated compounds and hydrogenated compounds such as AsH₃, AsF₃, AsCl₃, AsBr₃, AsF₅, SbH₃, SbF₃, SbF₅, SbCl₃, SbCl₅, BiH₃, BiCl₃, BiBr₃ and the like can be exemplified.

These material substances for introduction of the atom controlling conductivity may be, in leading to the reaction container, used by dilution with H₂ and/or He in necessary occasions.

In addition, in the photoreceptor 403 for electrophotography according to the present invention, in the photoreceptor for electrophotography according to the present invention, for the amorphous silicon film, which contains the hydrogen atom or/and halogen atom, required for the photoconductive layer, in addition to silicon as a basic material, the amorphous silicon film containing a small quantity of carbon atom and/or oxygen atom and/or nitrogen atom can be partially used. In this occasion, in comparison with the sum of silicon atom, carbon atom, oxygen atom and nitrogen atom, which constitute the amorphous silicon film, it is preferable that individual content is determined to realize in accordance with a purpose of addition that content of carbon atom and/or oxygen atom and/or nitrogen atom falls in a range from 1×10⁻⁵ to 10 atom percents by summation; preferably, in the range of 1×10⁻⁴ to 8 atom percents; more preferably, 1×10⁻³ to 5 atom percents. Carbon atom and/or oxygen atom and/or nitrogen atom in the photoconductive layer 403 can be adapted to have no distribution in the direction of the film thickness and can be adapted to have a distribution in the direction of the film thickness and also have a part changeable in content.

In the photoreceptor for electrophotography according to the present invention, the film thickness of the photoconductive layer 403 is selected so as to exceed the film thickness, in which absorbance of light for exposure necessary for yielding desired electrophotographic characteristics are achieved, and in consideration of economic characteristics and the like such as a step required by fabrication thereof, it is determined properly in accordance with light intensity and light wavelength of the exposure light. For example, in the case where the wavelength of the exposure light same as that of a conventional electrophotographic apparatus employing a laser light as the exposure light, the film thickness of the photoconductive layer 403 is determined to fall in the range from 20 to 50 μm, preferably 23 to 45 μm, more preferably 25 to 40 μm. Under this exposure condition, when the film thickness of the photoconductive layer 403 becomes thinner than 20 μm, as thickness as thinner, electrophotographic characteristics such as electrifiability and sensitivity become insufficient for practical use. On the other hand, when it becomes thicker than 50 μm, time required for preparation of the photoconductive layer prolongs and fabricating cost rises to become inappropriate in economic view point.

In the photoreceptor for electrophotography according to the present invention, for preparation of the photoconductive layer 403, the conditions for formation of the film, such as the material gas for Si supply and other material gases, the mixing proportion with the dilution gas, the pressure inside the reaction container, the discharging electric power, and the temperature of the supporting member, must be set properly in accordance with film characteristics desired.

The pressure inside the reaction container is properly selected in accordance with the material gas for Si supply and other material gases, the mixing proportion with the dilution gas, the discharging electric power; however, in using the high frequency glow discharge method using the high frequency electric power of the RF band, it is selected from the range of at least 1.0×10⁻² to 5.0×10⁴ Pa, preferably 5.0×10⁻² to 1.0×10⁴ Pa, more preferably 1.0×10⁻¹ to 5.0×10³ Pa.

The discharging electric power is also preferable to be properly selected from the range to maintain a stable plasma according to the material gas for Si supply and other material gases, the mixing proportion with the dilution gas, and the pressure inside the reaction container.

In addition, the temperature of the supporting member 401 is selected according to the composition of the objective deposition film to be obtained and also the state of plasma generated in the reaction container. In applying, for example, the high frequency glow discharge method using the high frequency power of the RF band, it is preferable to select from 200 to 350° C., preferably 230 to 330° C., more preferably 250 to 310° C.

In the photoreceptor for electrophotography according to the present invention, for preparation of the photoconductive layer 403, for example, in case applying the high frequency glow discharge method using the high frequency power of the RF band, the preferable ranges of the temperature of the supporting member and the pressure inside the reaction container have been described above. Generally, the condition for film preparation is not independently determined, but in order to prepare the deposition film having the desired characteristics, it is preferable to select the most suitable values by comprehensive decision based on an inter- and organic relationship between the conditions of the film preparation.

(Surface Layer)

In the photoreceptor for electrophotography according to the present invention, the photosensitive layer 402 formed on the supporting member 401 under conditions as described above requires further layering of the surface layer 404 based on amorphous silicon on the photoconductive layer 403. This surface layer 404 has a free surface 410 becoming the surface entirely over the photosensitive layer 402 and presents a function to achieve moisture resistance, continuously repeated use characteristic, dielectric strength, environmental characteristic in use, and durability and the function of inhibition of electric charge injection from the surface and also, takes an important role for accomplishment of an excellent image quality of the purpose of the present invention.

Consequently, on the outermost surface of the surface layer 404, in comparison with the a-Si:H, X film used for the photoconductive layer 403, the material having a distinctly higher abrasion resistance, moisture resistance, and dielectric strength is selected. Between the material used for the surface region of the surface layer 404 and the material used for the photoconductive layer 403, a coupling region can be put to realize a smooth coupling each other to make a configuration of the surface layer 404 comprising a coupling region and the surface region and also, no coupling region can be put to compose the material of the surface region only.

For the surface layer 404, any material which has a property capable of deposition on an a-Si:H, X film used for the photoconductive layer 403 and is the material absent in a significant light absorption in a range of light wavelength of the exposure light, exemplified as follows, can be used: an amorphous material containing the material based on amorphous silicon (a-Si) such as amorphous silicon (hereafter, a-SiC:H, X) containing the hydrogen atom (H) and/or the halogen atom (X) and also containing the carbon atom, amorphous silicon (hereafter, a-SiO:H, X) containing the hydrogen atom (H) and/or the halogen atom (X) and also containing the oxygen atom, amorphous silicon (hereafter, a-SiN:H, X) containing the hydrogen atom (H) and/or the halogen atom (X) and also containing the nitrogen atom, amorphous silicon (hereafter, a-SiCON:H, X) containing the hydrogen atom (H) and/or the halogen atom (X) and also containing at least any one of the carbon atom, oxygen atom and nitrogen atom, and amorphous carbon (hereafter, a-SiC:H, X) having carbon atoms as basic material and containing the hydrogen atom (H) and/or the halogen atom (X) and also containing the silicon atom. For example, in the surface region of the surface layer 404, such amorphous materials as the a-SiC:H, X film and a-C:Si:H, X film, which contain the silicon atom and the carbon atom as the basic material, are preferably used.

In the photoreceptor for electrophotography according to the present invention, similar to the photoconductive layer 403, deposition of the surface layer 404 is also carried out in the predetermined film thickness by selecting such conditions as proper film preparation variables such as the flow rate of the material gas, the temperature of the supporting member, the pressure, and the high frequency electric power supply in order to yield the desired characteristics by the vacuum deposition method such as the plasma CVD method. Specifically, the plasma CVD method, in other words, the glow discharge method such as the alternate current CVD method such as the low frequency CVD method, the high frequency CVD method, or the microwave CVD method, the direct current CVD method or the like, by the vacuum deposition method to decompose the material gas. In fabricating the photoconductive layer having the desired characteristic, because of relatively easy control of film preparation condition, particularly among plasma CVD methods using the high frequency power of the RF band or a VHF band, use of the high frequency glow discharge is more preferable.

In the photoreceptor for electrophotography according to the present invention, similar to the photoconductive layer 403, the surface layer 404 can also receives the atom to control conductivity in necessary occasion. In the occasion, in order to make content of the atom to control conductivity small, the material substance for introduction of the atom to control conductivity may be used by diluting with the gas such as H₂, He, Ar and Ne in necessary occasion. For reference, also in the surface layer 404, as the atom to control conductivity, use of the atom of the IIIb group and the atom of the Vb group is preferable to yield the p-type conductive characteristic and the n-type conductive characteristic, respectively.

In the photoreceptor for electrophotography according to the present invention, the film thickness of the surface layer 404, as long as attenuation of a surface electric potential is carried out effectively by light carrier generated in the photoconductive layer 403 and also as long as significant attenuation does not occurs in light intensity of the exposure incident light to the photoconductive layer 403, can make thicker. For reference, though the surface layer 404 is an excellent abrasion resistive material, when use of the light receiving member is continued in the electrophotographic apparatus, it is worn little by little.

Thus, the film must have a thickness not lost by such abrasion for a long period. Therefore, unless any quality is considered, as a rule, the film thickness of the surface layer 404 is preferable to be selected from the range of 0.01 to 3 μm, preferably 0.05 to 2 μm, more preferably 0.1 to 1 μm. According to the film thickness of surface layer 404 becoming thinner than 0.01 μm, by cause such as abrasion during use of light receiving member, frequency of lost of the surface region of the surface layer 404 increases. On the other hand, if thickness becomes over 3 μm, light carrier capture in a deeper level existing in the film of the surface layer 404 increase and thus, deterioration, such as increase in a rest electric potential, of electrophotographic characteristics becomes prominent gradually.

In formation of the deposition film used for the surface layer 404, the condition of preparation of the film is properly selected as the film yielded to satisfy characteristics required by the surface layer. In other words, for the surface layer 404, the substance of which constitutional element is Si, C, H, and/or X is used. For example, SiC is, structurally, can have various morphologies from various crystal types to amorphous type and hence, for example, the condition of film preparation to give an amorphous form is selected. In addition, inherently, even if it is semiconductor-like amorphous, electric physical properties show various aspects of conductivity from conductive property to insulation and further, in accordance with an optical forbidden bandwidth thereof, in light wavelength of the exposure light, become either light conductive property or non-light conductive property. However, these electric and optical properties also determined depending on the condition of film preparation. Therefore, in preparing the deposition film used for the surface layer 404, the condition of preparation, in addition to composition, of the film is properly selected to have desired characteristics of electric and optical properties thereof.

In formation of the surface layer 404, in accordance with the deposition method employed, the temperature of the supporting member 401 and the pressure inside the reaction container must be properly set to yield the objective composition of the deposition film, electric and optical properties thereof.

The temperature (Ts) of the supporting member 401 is selected in accordance with the objective composition of the deposition film and also the plasma state generated in the reaction container; for example, in using the high frequency glow discharge method using the high frequency power of the RF band, selected preferably from ranges of 200 to 350° C., preferably 230 to 330° C., more preferably 250 to 300° C.

The pressure inside the reaction container is properly selected in accordance with the objective composition of the deposition film or the material gas for Si supply and other material gases, the mixing proportion with the dilution gas, and the discharge electric power and for example, in using the high frequency glow discharge method using the high frequency power of the RF band, selected preferably from ranges of at least 1.0×10⁻² to 1.0×10³ Pa, preferably 5.0×10⁻¹ to 1.0×10² Pa, more preferably 1.0×10⁻¹ to 1.0×10² Pa.

The discharge electric power is also properly selected, in accordance with the material gas for Si supply and other material gases, the mixing proportion with the dilution gas, and the pressure inside the reaction container, from the range to maintain the stable plasma.

In the photoreceptor for electrophotography according to the present invention, in preparing the surface layer 404 on the photoconductive layer 403, for example, in case using the high frequency glow discharge method using the high frequency power of the RF band, preferable ranges have been described above for the temperature of the supporting member and the pressure inside the reaction container. However, as a rule, the condition of film preparation cannot be independently determined, but in order to form the deposition film having the desired characteristics, on the basis of the inter- and organic relationship between conditions of the film preparation, comprehensive decision must be required to select the most suitable value.

(Charge-injection Blocking Layer)

In the photoreceptor for electrophotography according to the present invention, between the supporting member 401 and the photoconductive layer 403, a charge-injection blocking layer 405 can be put to take a role of inhibition of charge injection from the supporting member 401 side in the photoconductive layer 403. By preparing the charge-injection blocking layer 405, without irradiation o the exposure light, by charge injection from the supporting member 401, a phenomenon of attenuation of the surface electric potential is effectively prevented and thus, also in the photoreceptor for electrophotography according to the present invention, it is more preferable to prepare the charge-injection blocking layer 405. Specifically, the charge-injection blocking layer 405, when the free surface of the photosensitive layer 402 subjected to electrification has been electrified in a certain polarity, has a function to inhibit injection of the electric charge from the supporting member 401 side in the photoconductive layer 403 by the electric field, however, in electrified in a reverse polarity, the function to inhibit injection of the electric charge does not appear, and then it is said as has so-called polarity-dependency. In order to achieve the above described function, the charge-injection blocking layer 405 is made as the film having the same conductivity as the photoconductive layer 403 and content of atoms controlling the conductivity is significantly increased in comparison with content in the photoconductive layer 403.

Atoms contained in the charge-injection blocking layer 405 and controls the conductivity, may be contained to make the distribution of the concentration even in the direction of the film thickness, or though the concentration thereof is higher than the concentration in the photoconductive layer 403, the distribution of the concentration of the atom may be given to the direction of the film thickness thereof to make the region containing the atom partially in high concentration. In case making the concentration distribution, the region of the high concentration is preferably prepared in the supporting member side.

For reference, despite that concentration distribution is prepared or not in the direction of the film thickness, in the direction of a face parallel to the surface of the supporting member, atoms to control conductivity is required to be contained to make the concentration even and characteristics in the direction in the face of the photosensitive layer is required to be even.

As atoms contained in the charge-injection blocking layer 405 to control conductivity, similar to the above described photoconductive layer 403, so-called impurities in the semiconductor field can be exemplified; for example, when the n-type conductive property is given, atoms of the Vb group can be used.

As usable atoms of the Vb group, specifically, phosphorus (P), arsenite (As), antimony (Sb), and bismuth (Bi) are exemplified; particularly, P and As are particularly preferable.

In the photoreceptor for electrophotography according to the present invention, content of atoms controlling conductivity and contained in the charge-injection blocking layer 405, as described above, according to content in the photoconductive layer 403, is selected to increase significantly. Normally, content of atoms controlling conductivity and contained in the charge-injection blocking layer 405 is preferably selected from ranges of 1×10¹ to 1×10⁴ atom ppm; preferably, 5×10¹ to 5×10³ atom ppm; more preferably, 1×10² to 3×10³ atom ppm. Distribution of concentration of atoms may be in the direction of the film thickness. However, in the occasion, in at least in the region in which atoms are contained in a high concentration, the above described range is preferably selected.

In the charge-injection blocking layer 405, the same material as the photoconductive layer 403, specifically, the a-Si:H, X film, can be used. In addition, by containing at least any one of the carbon atom, nitrogen atom, and oxygen atom, close contact between the charge-injection blocking layer 405 and the supporting member 401 can be further realized.

In the charge-injection blocking layer 405, in containing further the above described the carbon atom or oxygen tom or nitrogen atom, the distribution of content in the direction of the film thickness can be made even, or the distribution of content is set in the direction of the film thickness and for example, in an interface between the charge-injection blocking layer 405 and the photoconductive layer 403, compositions of both layers coincide. On the other hand, in an interface between the charge-injection blocking layer 405 and the supporting member 401, content can be set to be higher. For reference, despite that concentration distribution is prepared or not in the direction of the film thickness, in the direction of a face parallel to the surface of the supporting member, carbon atom or nitrogen atom or oxygen atom is contained to make content even and characteristics in the direction in the face of the photosensitive layer is required to be even.

In the charge-injection blocking layer 405, content of the carbon atom and/or oxygen tom and/or nitrogen atom further contained to the a-Si:H, X film is, for example, properly selected according to the purpose thereof such as improvement of close contact. However, for example, in using the a-Si:H, X film for the photoconductive layer 403, in case containing any one species, the content therefore is preferably selected or in case containing two or more species, as the sum of the contents, selection is preferably carried out from ranges of 1×10⁻³ to 30 atom percents; preferably, 5×10⁻³ to 20 atom percents; more preferably, 1×10⁻² to 10 atom percents.

In such amorphous materials as a-Si:H, X used for the charge-injection blocking layer 405, the hydrogen atom and/or the halogen atom contained compensates the unused valence existing in the amorphous material film to influence to improvement of quality of the film. In such amorphous materials as a-Si:H, X used for the charge-injection blocking layer 405, content of the hydrogen atom or the halogen atom or the sum of the hydrogen atom and the halogen atom is preferably selected from ranges of 1 to 50 atom percents; preferably, 5 to 40 atom percents; more preferably, 10 to 30 atom percents.

In the photoreceptor for electrophotography according to the present invention, the thickness of the film of the charge-injection blocking layer 405 is, to achieve the desired charge-injection blocking function and in consideration of economy such as time required for preparation thereof, properly selected in accordance with content of atoms to control conductivity thereof. Normally, the thickness of the film of the charge-injection blocking layer 405 is preferably selected from the ranges of 0.1 to 8 μm, preferably 0.3 to 6 μm, more preferably 0.5 to 4 μm. Regardless of a strength of the electric field caused by the surface electric potential electrified, as film thickness as thinner than 0.1 μm, the charge-injection blocking function for an electric charge from the supporting member becomes insufficient to yield no electrifiability desired. On the other hand, regardless of content of the atom controlling the conductivity, even if the thickness is increased than 8 μm, further improvement of the charge-injection blocking function can be hardly expected, causes rise of fabricating cost due to prolongation of time for preparation, and thus, is not preferable in viewpoint of economy.

In the photoreceptor for electrophotography according to the present invention, as the method for preparation of the charge-injection blocking layer, the vacuum deposition method similar to method for preparation of the above described photoconductive layer is preferably applied. Similar to the photoconductive layer 403, the charge-injection blocking layer 405 is, to yield the desired characteristics by such the vacuum deposition film preparation method as the plasma CVD method, variables, specifically conditions of the flow rate of the material gas, the temperature of the supporting member, the pressure, and the high frequency electric power supply are selected to deposit with the predetermined thickness. Specifically, preparation is preferably carried out through that the plasma CVD method, in other words, the glow discharge method (the alternate current CVD method such as the low frequency CVD method, the high frequency CVD method, or the microwave CVD method, the direct current CVD method, or the like), is used to decompose the material gas by the vacuum deposition method. In fabricating the photoconductive layer having the desired characteristic, because of relatively easy control of film preparation condition, among plasma CVD methods, use of the high frequency glow discharge using the high frequency power of the RF band is particularly more preferable.

In forming the charge-injection blocking layer 405, as same as the photoconductive layer 403, the mixing proportion of the material gas for Si supply and other material gases with the dilution gas, the pressure inside the reaction container, the discharge electric power, and the temperature of the supporting member 401 are properly selected in accordance with the composition of the material used.

For example, the flow rate of H₂ and/or He being dilution gas is properly selected in accordance with the composition of the material used. For example, to the flow rate of the material gas for Si supply, the flow rate of H₂ and/or He being dilution gas is preferably selected from the range of 0.3 to 20 times, preferably 0.5 to 15 times, and more preferably 1 to 10 times.

The pressure inside the reaction container is properly selected in accordance with the composition of the objective composition of the deposition film or the material gas for Si supply and other material gases, the mixing proportion with the dilution gas, and the discharge electric power and for example, in using the high frequency glow discharge method using the high frequency power of the RF band, selected from ranges of at least 1.0×10⁻² to 1.0×10³ Pa, preferably 5.0×10⁻¹ to 5.0×10² Pa, more preferably 1.0×10⁻¹ to 1.0×10² Pa.

The discharge electric power is also properly selected, in accordance with the material gas for Si supply and other material gases, the mixing proportion with the dilution gas, and the pressure inside the reaction container, from the range to maintain the stable plasma. Depending on the pressure inside the reaction container, a ratio of the discharge electric power (W) to the flow rate (ml/min (normal)) of the material gas for Si supply is preferably set to the ranges of 0.5 to 8, preferably 0.8 to 7, more preferably 1 to 6.

In addition, the temperature (Ts) of the supporting member 401 is selected in accordance with the objective composition of the deposition film and also the plasma state generated in the reaction container; for example, in using the high frequency glow discharge method using the high frequency power of the RF band, selected preferably from ranges of 200 to 350° C., preferably 230 to 330° C., more preferably 250 to 310° C.

In the photoreceptor for electrophotography according to the present invention, in forming the charge-injection blocking layer 405, for example, in using the high frequency glow discharge method using the high frequency power of the RF band, the preferable ranges have been described for the temperature of the supporting member the pressure inside the reaction container, the discharge electric power, and the mixing proportion with the dilution gas. Normally, conditions of the film preparation cannot be independently determined, but in order to form the deposition film having the desired characteristics, on the basis of the inter- and organic relationship between conditions of the film preparation, comprehensive decision must be required to select the most suitable value.

In addition, in the photoreceptor for electrophotography according to the present invention, in the above described supporting member 401 side in the photoconductive layer 402, the layer of the amorphous material film containing at least the aluminum atom, silicon atom, hydrogen atom and/or halogen atom is prepared to give the distribution of the composition in the direction of the film thickness and in the interface layer thereof between the photoconductive layer 403 or the charge-injection blocking layer 405 deposited thereon, the composition is more preferable to be constituted having the region which is adapted to be a smoothly continued state. This region containing the aluminum atom and silicon atom presents an effect to increase close contact to the supporting member made of aluminum or an aluminum alloy.

In the photoreceptor for electrophotography according to the present invention, with the purpose to improve further close contact of the supporting member 401 to the photoconductive layer 403 or the charge-injection blocking layer 405, which is stacked by contacting thereto, for example, Si₃N₄, SiO₂, SiO, or silicon atom is used as the base material, the hydrogen atom and/or halogen atom is contained, the carbon atom and/or oxygen atom and/or nitrogen atom is further contained to build up the amorphous material used for the close contacting layer. In addition, the exposure incident light from the surface of the photoconductive layer 402 is reflected by the surface of the supporting member and to prevent an occurrence of this interference phenomenon caused by the reflection, the light absorbing layer can be put on the surface of the supporting member to make the constitution.

(Method for Preparing the Deposition Film and An Apparatus Used Therefor)

Next, in preparation of the photoreceptor for electrophotography according to the present invention, the apparatus for preparing the deposition film to prepare various species of the amorphous material film used for the above described photosensitive layer and the method for preparing the deposition film will be described in detail.

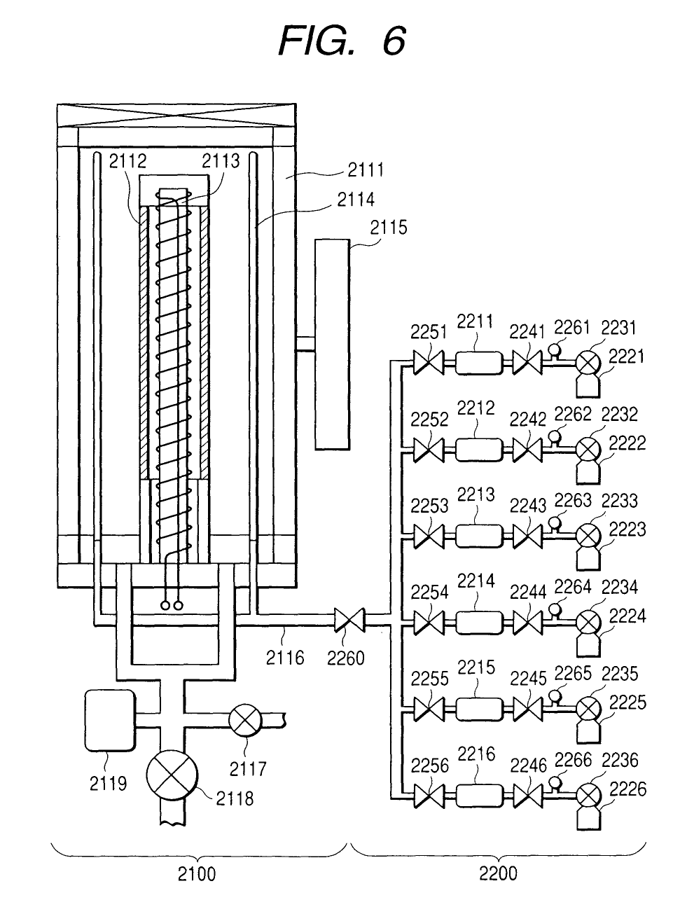

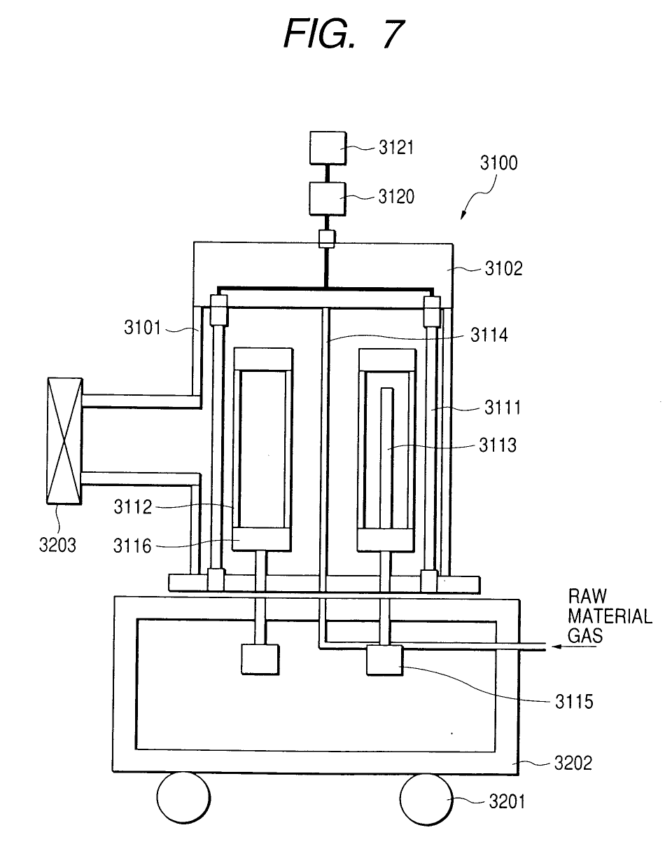

FIG. 6 is the figure showing the example of the apparatus for preparing the deposition film by the high frequency plasma CVD methods (hereafter, RF-PCVD) using the high frequency power of which electric supply frequency is of the RF band and also showing a configuration of the apparatus diagrammatically. The configuration of the apparatus for preparing the deposition film shown in FIG. 6 is as follows.

This apparatus is roughly comprises a deposition apparatus (2100), a material gas supply apparatus (2200), and a ventilation apparatus (not shown) to reduce the pressure inside the reaction container (2111). In the reaction container (2111) in the deposition apparatus (2100), means for holding a cylindrical gas leading pipe (2112), a heater to heat the supporting member (2113), and a material gas leading pipe (2114) are installed and in a side wall part thereof, a high frequency matching box (2115) is connected.

The material gas supply apparatus (2200) comprises a cylinder (2221 to 2226) for material gases such as SiH₄, Si₂H₂Cl₂, H₂, CH₄, B₂H₆, and PH₃, a valve (2231 to 2236, 2241 to 2246, 2251 to 2256), and a mass flow controller (2211 to 2216). The cylinder of each material gas is, through the valve 2260, connected to the material gas-leading pipe (2114) in the reaction container (2111).

The deposition film can be prepared by employing this apparatus as follows. First, the cylindrical gas leading pipe (2112) is installed in the reaction container (2111) and exhaust is carried out for the reaction container (2111) by using an exhausting apparatus (for example, a vacuum pump) not shown.

Subsequently, the cylindrical gas leading pipe (2112) is heated by the heater to heat the supporting member (2113) and the surface temperature of the cylindrical gas leading pipe (2112) is heated regulating it to the predetermined temperature selected from the range from 200° C. to 350° C.

In order to lead the material gas for preparation of the deposition film into the reaction container (2111), after confirmation of closing of the valve (2231 to 2237) of the gas cylinder and a leak valve (2117) of the reaction container and also, confirmation of opening of a inlet valve (2241 to 2246) an outlet valve (2251 to 2256) and a auxiliary valve (2260), a main valve (2118) is opened to exhaust first the reaction container (2111) and a gas piping (2116).

Next, using a vacuum gauge (2119) at a point where a vacuum degree inside the reaction container (2111) becomes for example about 5×10⁻⁶ Torr (1 Torr corresponds to 133.322 Pa) and sufficient exhaust has been completed, the auxiliary valve (2260) and the outlet valve (2251 to 2256) are closed.

Thereafter, each gas is led from the cylinder (2221 to 2226) by opening by the valve (2231 to 2236) and the pressure of each gas is regulated to 2 Kgf/cm² by using a pressure regulator (2261 to 2266). Next, the inlet valve (2241 to 2246) are gradually opened to lead each gas to the mass flow controller (2211 to 2216).

After completion of the above operations resulting in completion of preparation of the film, the deposition film of each layer is formed by the following sequence.

When a cylindrical supporting member (2112) is regulated to a predetermined temperature, among the outlet valve (2251 to 2256), those corresponding to a predetermined gas required for film preparation and the auxiliary valve (2260) are gradually opened to lead a predetermined gas from the gas cylinder (2221 to 2226) through the material gas leading pipe (2114) to the reaction container (2111). At this time, by the mass flow controller (2211 to 2216), each material gas is regulated to become the predetermined flow rate. On the other hand, to make the pressure inside the reaction container (2111) to the predetermined pressure, for example, under 1 Torr, the opening of the main valve (2118) is adjusted by monitoring the pressure by using the vacuum gauge (2119).

When the pressure inside the reaction container (2111) has been stabilized in the predetermined pressure, an RF electric power supply (not shown) of a frequency of 13.56 MHz, for example, is set to a predetermined electric power to feed an RF electric power to the reaction container (2111) through the high frequency matching box (2115) to generate glow discharge. By this discharge energy, the material gas led to the reaction container (2111) is decomposed to form the deposition film having the predetermined composition on the cylindrical supporting member (2112). After completion of the formation of a desired film thickness, supply of the RF electric power is stopped and the outlet valve is closed to stop a flow of the gas in the reaction container finally resulting in completion of preparation of the deposition film.

By repeating the same operations of a plurality of frequencies in necessary occasions, the photosensitive layer with a desired multilayer structure on the cylindrical supporting member.

In sequential formation of a plurality of layers, it is needless to say that all outlet valves for gases other than that necessary for preparation of the deposition film have been closed. Further, in order to avoid remaining of the gas used for the previous formation of the deposition film in piping system from the outlet valve (2251 to 2256) to the reaction container (2111) the following operations are conducted in a necessary occasion: the outlet valve (2251 to 2256) are closed and the auxiliary valve (2260) is opened and further, the main valve (2118) is fully opened to exhaust from the reaction container (2111) once to make a high vacuum state.

In addition, in order to intend to make the thickness of the film deposited even, during operation of the deposition film preparation, it is effective that the supporting member (2112) is rotated in a predetermined speed by a driving apparatus (not shown). In many occasions, rotation of the supporting member (2112) is carried out.

In addition, it is needless to say that selection of gas species described above and setting of flow rate and valve operation are serially changed to the predetermined condition in accordance with the condition of preparation of the amorphous material film used for each layer

The temperature of the supporting member in preparing the deposition film, for example, in using the RF high frequency electric power of the frequency of 13.56 MHz, the ranges is set to 200 or higher to 350° C., preferably 230 to 330° C., more preferably 250 to 310° C. In the apparatus shown in FIG. 6, the heater to heat the supporting member (2113) of a wound heater type is used. A method for heating the supporting member may be a heating element having a specification usable for the vacuum container and more specifically, an electric resistance heating element such as a wound heater of a sheath-like heater, a plate-like heater and a ceramic heater, a heat-radiating lamp type heating element such as a halogen lamp and an infrared lamp, and the heating element such as by heat exchange means with warming medium such as a liquid and a gas are exemplified. The material of the surface of the heating means can be a metal such as stainless steel, nickel, aluminum and copper, ceramics, and heat resistive high polymer resin.

Other than these systems employing direct heating in the reaction container, the following method can be applied: a container for exclusive use for heating is installed other than the reaction container to heat once followed by carrying the supporting member in vacuum in the reaction container.

In FIG. 7, the example of the apparatus of the high frequency plasma CVD methods (hereafter, VHF-PCVD) using the VHF band is shown. The VHF-PCVD apparatus exemplified by FIG. 7 is the example in which replaced to the deposition apparatus (2100) of FIG. 6, the deposition apparatus (3100) of FIG. 7 is used and the material gas supply apparatus having the same configuration as that of the material gas supply apparatus (2200) shown in FIG. 6 is connected thereto to build up the deposition film-preparing apparatus by the VHF-PCVD. This apparatus mainly comprises a movable deposition apparatus (3100) installed in a heating area (not shown) a gate valve (3203) for connection of an exhaust part is connected to the exhaust apparatus, and a cylindrical base body (3112) is heated and controlled to the predetermined temperature.

Thereafter, the gate valve (3203) for connection of the exhaust part is separated and the movable deposition apparatus (3100) is moved to a film-forming area (not shown). The gate valve (3203) for connection of the exhaust part is connected to the ventilation apparatus of the film-forming area and a connecting part is fixed.

The gate valve (3203) of the exhaust part and the gate valve in the exhaust apparatus side (not shown) are opened to exhaust inside the movable deposition apparatus (3100).

The movable deposition apparatus (3100) comprises an SUS-made shield (3102), the cylindrical reaction container (3101) made of an Al alloy, a reaction container supporting stand (3102), the gate valve (3203) for connection, and a movable caster (3201).

Inside the reaction container (3101), base body-holding means, which has six holders (3116) loaded with cylindrical supporting members (3112) respectively with equal distances on concentric circles, and base body heating heater (3113) and in a center, 1 material gas leading pipe (3114) are installed. In addition, 6 SUS-made rod-like high frequency electrode (3111) are arranged with equal distances on concentric circles and through the high frequency matching box (3120), the high frequency electric power supply (3121) of the VHF band is connected.

For deposition film formation, the material gas is led to the reaction container (3101) through the material gas leading pipe (3114). Flow rate of the material gas becomes a set flow rate and the inside of the reaction container (3101) is made to the predetermined pressure, the high frequency power is supplied to generated glow discharge, and the material gas is excited and dissociated to make the deposition film on the cylindrical supporting member (3112). According to the configuration, during preparation of the deposition film, a motor (3115) is actuated to rotate the cylindrical supporting member (3112).

After deposition of the desired film thickness is completed, supply of the high frequency power is stopped and subsequently, supply of the material gas is stopped to finish preparation of the deposition film. In case preparing the deposition film with the multilayer structure, same operation is repeated in a plurality of frequencies.

(A Method for Electrophotography and an Apparatus for Electrophotography)

Next, the apparatus for electrophotography of a BAE exposure system employing the photoreceptor for electrophotography according to the present invention and the method for electrophotography according to the present invention to carry out image formation by using the apparatus for electrophotography will be described in detail.

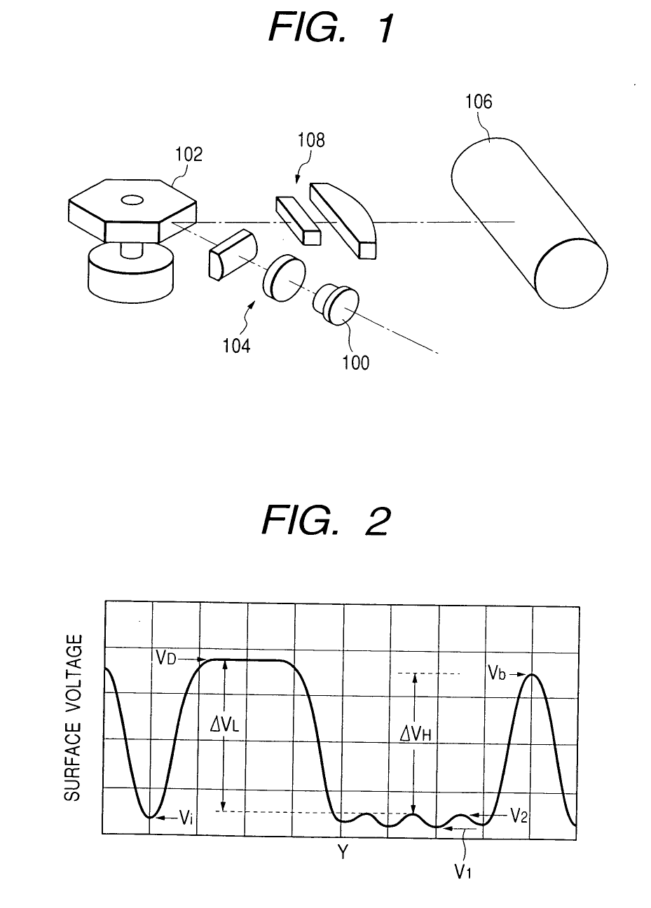

FIG. 1 shows diagrammatically the example of means for irradiating the light for image formation applied to the method for electrophotography according to the present invention. The means for irradiating the light for image formation shown in FIG. 1 is configured by having a laser light source (laser diode) 100 as an exposure light source and a light source optical system 104 and by using a rotative multi-way mirror 102 and a scanning optical system 108, the surface of the photoreceptor 106 for electrophotography is exposed by scanning.

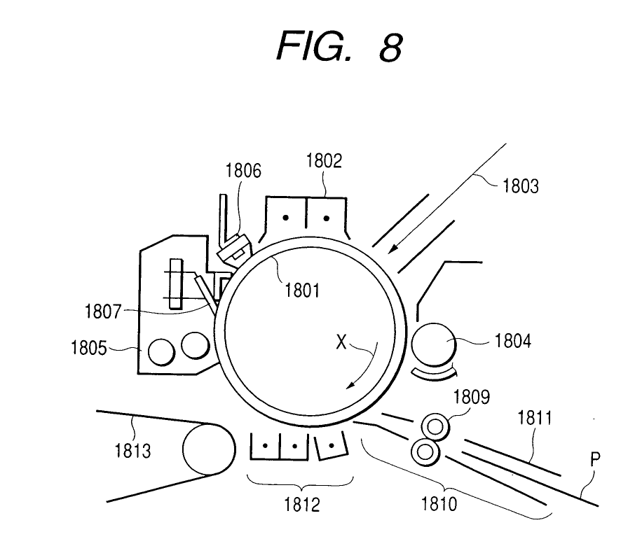

FIG. 8 shows the example of the configuration of a main part of the apparatus for electrophotography used in the method for electrophotography according to the present invention. In FIG. 8, a rotative cylindrical photoreceptor 1801 is rotated in an X direction. Around the rotative cylindrical photoreceptor 1801, adjacent to the above described photoreceptor 1801, a main electrifier 1802, an exposure light beam 1803, a developer 1804, a feeding system 1810 for a transferring paper, a transfer and separation electrifier 1812, a cleaning apparatus 1805, a main diselectrifying light source 1806, a carrying system 1813 and the like are installed.

The main electrifier 1802 evenly electrifies the photoreceptor 1801. Next, by the means for irradiating the light for image formation, in accordance with the image information, the exposure light beam 1803, of which light intensity has been modulated, is irradiated on the surface for scanning exposure. By this scanning exposure, a latent image is formed on the photoreceptor 1801. In the method for electrophotography according to the present invention, for an image finally transferred as a toner image, background exposure method, by which exposes by scanning the region being a background, in other words, non-image part (background), is adopted.

Thereafter, to the latent image formed on the photoreceptor 1801, toner is supplied from the developer 1804 to make a visualized image, i.e., a toner image. By the background exposure method, the image portion not exposed has a high surface electric potential and toner attaches thereto.

On the other hand, a transferring material P, for example, a printing paper, passes through a transferring-paper supply system 1810 comprising a path for the transferring paper 1811 and a resist roller 1809 to be supplied to the direction of the photoreceptor 1801. The transferring material P supplied receives, in a space between the transfer electrifier 1812 and the photoreceptor 1801, an electric field, with a polarity opposite to toner, from a back face and by this, the toner image on the surface of the photoreceptor is transferred to the transferring material P.

The transferring material P separated passes through the feeding and carrying system 1813 for the transferring paper to reach a fixing apparatus (not shown) to subjected to heating and fixing of the toner image transferred to the surface finally resulting in discharge to outside of the apparatus.

For reference, in a transferring site, toner not transferred to the surface of the transferring material P is left on the surface of the photoreceptor 1801 as it is. This toner left reaches the cleaning apparatus 1805 and removed by a cleaning blade 1807 to clean the surface of the photoreceptor 1801. The photoreceptor 1801 renewed by cleaning is further subjected to irradiation of diselectrifying light from the main diselectrifying light source 1806 to eliminate the surface electric potential through the previous image forming process. And, it is again supplied to the next image preparation process.

In the method for electrophotography according to the present invention, for the photoreceptor used for the above described series of image preparation process, by using the photoreceptor for electrophotography, as described above, according to the present invention, mainly in the background exposure method, a phenomenon (roughness), in which fine dot-like transfer of toner occurs according to insufficient attenuation of the surface electric potential in irradiation of the exposure light on the back portion of to be exposed by scanning, is more effectively omitted to achieve a clear image. Particularly, such roughness itself is prominent in using the light beam with a small diameter of a spot and a large light intensity thereof in irradiation of the exposure light and the method for electrophotography according to the present invention, is the method more effective in using for the light beam with the small diameter of the spot of the exposure light source, specifically, the laser for the exposure light source.

### EXAMPLES

The present invention will be described below more specifically with reference to an Experimental Example and a example. These Experimental Example and example are examples of best embodiments according to the present invention. However, the present invention is not restricted to these specific examples.

### Experimental Example 1

By changing a relation between an average diameter of the crystal boundary of an aluminum alloy-made supporting member used for the photoreceptor and the diameter of the spot of the light beam used for the exposure light, the effect on the image quality yielded was examined.

For the cylindrical supporting member with a diameter of 108 mm, a length of 358 mm, and a thickness of a 5 mm, Al—Mg alloy with the base material made of 1N90, to which magnesium of about 2 wt percents was added, was used. In eight supporting members having average diameters shown in Table 1 regarding the boundary of crystal exposed to the surfaces thereof the photosensitive layers having the same layering structures on the surfaces thereof were formed to use them as the photoreceptors.

The supporting members, after subjected to cutting and mirror finishing of the surface, under the condition shown in Table 2, surface treatment was carried out using water.

However, water used for the surface treatment was pure water with a resistivity of 20 MΩ·cm and an aqueous solution of carbon dioxide was prepared by dissolving carbon dioxide in pure water as described above and then, an electric conductivity of water was adjusted to 10 μS/cm to 40 μS/cm. First, as prewashing, in aqueous detergent solution prepared by dissolving a surfactant in the above described water, the surface after mirror finish was ultrasonically washed to remove a matter rested after attached in processing. Subsequently, it was soaked in the aqueous solution of carbon dioxide to perform treatment using the aqueous solution of carbon dioxide and finally, blow drying was performed using dried and heated air. In the above described treatment using the aqueous solution of carbon dioxide, thereafter, on the surface of the photosensitive layer deposited on the surface of the supporting member, a projected structure was formed and a height of the projected part was made to 0.3 μm or smaller by adjusting the electric conductivity, water temperature, and time for treatment.

After the above described surface treatment, on each supporting member, the photosensitive layer comprising the charge-injection blocking layer, the photoconductive layer and the surface layer was prepared under preparation conditions shown in Table 3, respectively. On the photoreceptor prepared, observation of the surface of the photosensitive layer showed the crystal boundary corresponding to the crystal boundary of the surface of the supporting member and the projected structure was made on the boundary between crystal boundaries.

Eight species of the photoreceptor prepared was mounted on the apparatus (a Canon-made GP605 modified for experiment, a process speed was made variable, and an image exposure unit was made changeable) for electrophotography used for evaluation to evaluate the image quality yielded.

In the present experiment example, the conditions of image formation were 380 mm/sec of the process speed, image exposure by the laser light of a wavelength 680 nm, a 60 μm diameter of the spot of the light beam on the photoreceptor in a scanning direction and the image yielded was evaluated for the following items.

Image evaluation: a full face half tone and 1 line 5 spaces were treated as image samples to evaluate evenness of image density and line reproducibility.

Evaluation of “Evenness of Image Density”

The image density of the half tone image used for the image sample is set 1.20 in average by using a reflection type Macbeth densitometer and for an output image, by using the reflection type Macbeth densitometer, the image density was measured in a plurality of points to calculate a difference from the average image density thereof.

For the above described measuring point, 100 points were selected from an area of 10 cm² frame as used for measuring points. On the basis of difference from the average image density, the following 4 categories were scored.

Less than 2 percent: ⊚ very good

2 or more and less than 4 percent: ◯ good

4 or more and less than 6 percent: Δ no problem in practice

6 percent or more: × some problems may occur practically

Evaluation of “line reproducibility”

For the image yielded from the image sample of 1 line and 5 spaces, the image of 1 line edge was observed to count the number of toner particles developed and transferred to outside of a line image. On the basis of the number of toner particles outside of a line image, the following 4 classes were scored.

0 to 3: ⊚ very good

4 to 6: ◯ good

7 to 10: Δ no problem practically

11 or more: × somewhat problematic for practice

As exposure systems, both IAE system and BAE system were subjected to same evaluation of image quality. Table 4 shows both results of evaluation of the IAE system and the BAE system. From the results presented in Table 4, it can be known that in A4 to A8, of which average particle size of the crystal boundary of the aluminum alloy-made supporting member used for the photoreceptor is larger than the spot diameter of 60 μm of the light beam, regardless of the IAE system and the BAE system, evenness of image density and line reproducibility are good to yield a good image.

### Experimental Example 2

In this Experimental Example, on the 8 photoreceptors, A1 to A8, prepared in the above described Experimental Example 1, the spot diameter of the light beam of image exposure was changed to 30 μm in the scanning direction, the relation between the average diameter of the crystal boundary of the supporting member and the spot diameter of the light beam used for the exposure light was changed to examine an influence to the image quality similarly yielded.

The present Experimental Example 2, based on Experimental Example 1, other than the change of the spot diameter of the light beam used for the exposure light to 30 μm in the scanning direction, the same condition as that used in the method for evaluation of Experimental Example 1 was applied. On the other hand, the exposure system, for both the IAE system and BAE system, the evenness of image density and line reproducibility was evaluated.

Table 5 shows both results of evaluation of the IAE system and the BAE system. From the results presented in Table 5, it can be known that in A3 to A8, of which average particle size of the crystal boundary of the aluminum alloy-made supporting member used for the photoreceptor is larger than the spot diameter of 30 μm of the light beam, regardless of the IAE system and the BAE system, the evenness of image density and line reproducibility are good to yield a good image.

### Experimental Example 3

By changing the height of the projected structure generated on the surface of the photosensitive layer and the spot diameter of the light beam corresponding to the crystal boundary exposed to the surface of the aluminum alloy-made supporting member used for the photoreceptor, the effect on the height of the projected structure to the image quality was examined.

For the cylindrical supporting member with a diameter of 108 mm, a length of 358 mm, and a thickness of a 5 mm, Al—Mg alloy with the base material made of 1N90, to which magnesium of about 2 wt percents was added, was used. The average diameter of the crystal boundary exposed to the surface thereof was 150 μm. For the supporting members, after cutting and mirror finishing process of the surface, surface treatment using water was conducted under the condition shown in Table 2 of Experimental Example 1.

Also in the present Experimental Example, water used for the surface treatment was pure water with the resistivity of 20 MΩ·cm and the aqueous solution of carbon dioxide was prepared by dissolving carbon dioxide in pure water as described above and then, the electric conductivity was adjusted to 10 μS/cm to 40 μS/cm. In the above described treatment using the aqueous solution of carbon dioxide, thereafter, treatment was conducted for the surface of the photosensitive layer deposited on the surface of the supporting member to adapted to satisfy that the projected structure was formed and the height (average) of the projected part was made to range from 0.03 μm to 0.6 μm shown in Table 6 by adjusting the electric conductivity, water temperature, and time for treatment.

After the above described surface treatment, on each supporting member, the photosensitive layer comprising the charge-injection blocking layer, the photoconductive layer, and the surface layer was prepared under preparation conditions shown in Table 7, respectively. On the photoreceptor prepared, observation of the surface of the photosensitive layer showed the crystal boundary corresponding to the crystal boundary of the surface of the supporting member and the projected structure was made on the boundary between crystal boundaries. In order to calculate the height of the projected structure made on the photosensitive layer of the photoreceptor, by using AFM (QUESANT-made Qscope 250), the part of the boundary between crystal boundaries of the surface was scanned with a scanning width of 30 μm to 30 μm. On the basis of the scanned image, the average value of the height of the projected structure formed corresponding to the part of the crystal boundaries was calculated. From the result, eight photoreceptors with different heights of the projected structure on the photosensitive layer shown in Table 6 were selected.

The eight species of the photoreceptor prepared was mounted on the apparatus (the Canon-made GP605 modified for experiment, the process speed was made variable, and the image exposure unit was made changeable) for electrophotography used for evaluation to evaluate the image quality yielded. The BAE system was employed as the image exposure system.

In the present Experimental Example, the conditions of image formation were 380 mm/sec of the process speed, image exposure by the laser light of a wavelength 680 nm, two conditions, 60 μm and 30 μm diameters, of the spot of the light beam on the photoreceptor in a scanning direction and the image yielded was evaluated for the following variables.

Image Evaluation:

Evenness of image density and line reproducibility were evaluated. Evaluation steps were same as those of Experimental Example 1.

In addition, as the image sample for evaluation of separability, 10 sheets of paper of entirely white and entirely black were continuously fed to evaluate the image yielded. Three categories were applied: thoroughly separated=◯, occasionally not separated=Δ, and never separated=×.

Table 8 shows the result of evaluation. From the result of evaluation, it can be known that in B2 to B6, in which the height of the projected structure of the part of the boundary between crystal boundaries formed on the surface of the photosensitive layer of the photoreceptor ranges from 0.05 μm to 0.4 μm, the evenness of image density and line reproducibility are good to yield a good image.

On the other hand, concerning separability, as B1, when the height of the projected structure is less than 0.05 μm, contacting property to the transferring material such as paper increases and hence, separation did not occasionally succeeded in forming the entirely black image.

Therefore, it can be known that when the height of the projected structure of the part of the boundary between crystal boundaries formed on the surface of the photosensitive layer of the photoreceptor ranges from 0.05 μm to 0.4 μm, the result presenting good image quality and separation are yielded.

The present invention will be described below more specifically with reference to examples.

### Example 1

Using the deposition film-preparing apparatus by the RF-PCVD method shown in FIG. 6, on an aluminum cylinder (supporting member) having a 80 mm diameter and subjected to mirror finish, the photosensitive layer comprising the charge-injection blocking layer, the photoconductive layer and the surface layer was prepared to prepare the photoreceptor. In this occasion, the photoconductive layer is adapted to have two regions, i.e. a first region and a second region from the charge-injection blocking layer side. The first region and the second region correspond to the charge transporting layer and the lower charge generating layer, respectively.

Table 9 shows conditions of preparation of the photosensitive layer comprising the above described charge-injection blocking layer, photoconductive layer, and surface layer.

In the present example, a cylindrical Al—Mg alloy of 1N90 as a base material with about 3 percent by weight magnesium of 80 mm in diameter, 358 mm in length and 3 mm in thickness was used as a supporting member having the crystal boundaries with 100 μm in average diameter. On the other hand, for the surface of the supporting member, following the surface treatment ✓ steps described in the above described Experimental ✓ Example 3, in order to make the height of the projected structure part of the boundary of the crystal boundary formed on the surface of the photosensitive layer to 0.3 μm, treatment conditions of the aqueous solution of carbon dioxide, the electric conductivity, water temperature, and time in the surface treatment were adjusted.

The photoreceptor prepared was mounted on the apparatus (a Canon-made NP6750 modified for experiment, image exposure was carried out by changing to laser for scanning exposure by the BAE system and the spot diameter in scanning direction was 60 μm) for electrophotography to evaluate by the same manner as that of Experimental Example 3 and the good result was obtained for both the evenness of image density and line reproducibility.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, a good electrophotographic characteristics is yielded by the apparatus for electrophotography of the BAE system.

### Example 2

In the present example, in the photosensitive layer comprising the charge-injection blocking layer, the photoconductive layer and the surface layer, the photoconductive layer is adapted to have two regions, i.e., the first region and the second region from the charge-injection blocking layer side, and in difference from Example 1, the surface layer was prepared to adapted to have composition distribution status in that the content of silicon atom and carbon atom was distributed in the direction of the film thickness and the photoconductive layer side has more content of Si and the outermost layer has more content of C. For reference, the first region and the second region of the photoconductive layer correspond to the charge transporting layer and the charge generating layer, respectively.

Table 10 shows conditions of preparation of the photosensitive layer comprising the above described charge-injection blocking layer, photoconductive layer and surface layer.

In the present example, a cylindrical Al—Mg alloy of 1N90 as a base material with about 3 percent by weight magnesium of 80 mm in diameter, 358 mm in length and 3 mm in thickness was used as a supporting member having the crystal boundaries with 120 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.4 μm, treatment conditions of the aqueous solution of carbon dioxide, the electric conductivity, water temperature, and time in the surface treatment were adjusted.

The photoreceptor prepared was mounted on the apparatus (the Canon-made NP6750 modified for experiment, image exposure was carried out by changing to laser for scanning exposure by the BAE system and the spot diameter in scanning direction was 65 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 3

In the present example, in the photosensitive layer comprising the charge-injection blocking layer, the photoconductive layer and the surface layer, the photoconductive layer is adapted to have two regions, i.e., the first region and the second region from the charge-injection blocking layer side, and the surface layer was prepared to adapted to have composition distribution status in that the content of silicon atom and carbon atom was distributed in the direction of the film thickness and the photoconductive layer side has more content of Si and the outermost layer has more content of C. On the other hand, the charge-injection blocking layer, the photoconductive layer and the surface layer contain the nitrogen atom and in addition to the hydrogen atom, the fluorine atom has been contained. For reference, the first region and the second region of the photoconductive layer correspond to the charge transporting layer and the charge generating layer, respectively.

Table 11 shows conditions of preparation of the photosensitive layer comprising the above described charge-injection blocking layer, photoconductive layer and surface layer.

In the present example, a cylindrical Al—Mg alloy of 1N90 as a base material with about 3 percent by weight magnesium of 80 mm in diameter, 358 mm in length and 3 mm in thickness was used as a supporting member having the crystal boundaries with 80 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.25 μm, treatment conditions of the aqueous solution of carbon dioxide, the electric conductivity, water temperature, and time in the surface treatment were adjusted.

The photoreceptor prepared was mounted on the apparatus (the Canon-made NP6750 modified for experiment, image exposure was carried out by changing to laser for scanning exposure by the BAE system and the spot diameter in scanning direction was 70 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 4

In the present example, in the photosensitive layer comprising the charge-injection blocking layer, the photoconductive layer and the surface layer, the photoconductive layer is adapted to have serial two regions, i.e., the first region and the second region from the charge-injection blocking layer side, and in difference from Example 1, the surface layer was prepared by no use of the amorphous material containing silicon atom and carbon atom, but using the amorphous material containing silicon atom and nitrogen atom. For reference, the first region and the second region of the photoconductive layer correspond to the charge transporting layer and the charge generating layer, respectively.

Table 12 shows conditions of preparation of the photosensitive layer comprising the above described charge-injection blocking layer, photoconductive layer and surface layer.

In the present example, a cylindrical Al—Mg alloy of 1N90 as a base material with about 3 percent by weight magnesium of 80 mm in diameter, 358 mm in length and 3 mm in thickness was used as a supporting member having the crystal boundaries with 70 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.2 μm, treatment conditions of the aqueous solution of carbon dioxide, the electric conductivity, water temperature, and time in the surface treatment were adjusted.

The photoreceptor prepared was mounted on the apparatus (the Canon-made NP6750 modified for experiment, image exposure was carried out by changing to laser for scanning exposure by the BAE system and the spot diameter in scanning direction was 45 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, a good electrophotographic characteristic is yielded by the apparatus for electrophotography of the BAE system.

### Example 5

Using the deposition film-preparing apparatus by the RF-PCVD method shown in FIG. 6, on an aluminum cylinder (supporting member) having a 108 mm diameter and subjected to mirror finish, the photosensitive layer comprising the charge-injection blocking layer, the photoconductive layer, and the surface layer was formed to prepare the photoreceptor. In this occasion, the photoconductive layer is adapted to have serial two regions, i.e. the first region and the second region from the charge-injection blocking layer side, and the surface layer was prepared by using the amorphous material containing the nitrogen atom and the oxygen atom in addition to the silicon atom. For reference, the first region and the second region of the photoconductive layer correspond to the charge transporting layer and the charge generating layer, respectively.

Table 13 shows conditions of preparation of the photosensitive layer comprising the above described charge-injection blocking layer, photoconductive layer and surface layer.

In the present example, a cylindrical Al—Mg alloy of 1N90 as a base material with about 2 percent by weight magnesium of 108 mm in diameter, 358 mm in length and 5 mm in thickness was used as a supporting member having the crystal boundaries with 60 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.1 μm, treatment conditions of the aqueous solution of carbon dioxide, the electric conductivity, water temperature, and time in the surface treatment were adjusted.

The photoreceptor prepared was mounted on the apparatus (the Canon-made GP605 modified for experiment, image exposure was carried out by changing to laser for scanning exposure by the BAE system and the spot diameter in scanning direction was 40 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 6

In the present example, in the photosensitive layer comprising the charge-injection blocking layer, the photoconductive layer, and the surface layer, the photoconductive layer is adapted to have serial two regions, i.e. the first region and the second region from the charge-injection blocking layer side, and in difference from Example 5, the photoconductive layer and the surface layer was prepared by using CH₄ gas as the carbon source and using the amorphous material containing silicon atom and carbon atom. For reference, the first region and the second region of the photoconductive layer correspond to the charge transporting layer and the charge generating layer, respectively.

Table 14 shows conditions of preparation of the photosensitive layer comprising the above described charge-injection blocking layer, photoconductive layer and surface layer.

In the present example, a cylindrical Al—Mg alloy of 1N90 as a base material with about 2 percent by weight magnesium of 108 mm in diameter, 358 mm in length and 5 mm in thickness was used as a supporting member having the crystal boundaries with 150 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.3 μm, treatment conditions of the aqueous solution of carbon dioxide, the electric conductivity, water temperature, and time in the surface treatment were adjusted.

The photoreceptor prepared was mounted on the apparatus (the Canon-made GP605 modified for experiment, image exposure was carried out by changing to laser for scanning exposure by the BAE system and the spot diameter in scanning direction was 70 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 7

In the present example, in the photosensitive layer comprising the charge-injection blocking layer, the photoconductive layer, and the surface layer, the photoconductive layer is adapted to have serial two regions, i.e. the first region and the second region from the charge-injection blocking layer side, and the second region was prepared by using GeH₄ gas and using the amorphous material which contains the silicon atom and the germanium atom.

Table 15 shows conditions of preparation of the photosensitive layer comprising the above described charge-injection blocking layer, photoconductive layer and surface layer.

In the present example, a cylindrical Al—Mg alloy of 1N90 as a base material with about 2 percent by weight magnesium of 108 mm in diameter, 358 mm in length and 5 mm in thickness was used as a supporting member having the crystal boundaries with 80 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.1 μm, treatment conditions of the aqueous solution of carbon dioxide, the electric conductivity, water temperature, and time in the surface treatment were adjusted.

The photoreceptor prepared was mounted on the apparatus (the Canon-made GP605 modified for experiment, image exposure was carried out by changing to laser for scanning exposure by the BAE system and the spot diameter in scanning direction was 50 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 8

In the present example, in the photosensitive layer is prepared in a stratified structure comprising the charge-injection blocking layer, the photoconductive layer, an intermediate layer (the upper charge-injection blocking layer), and the surface layer, the photoconductive layer is adapted to have serial two regions, i.e. the first region and the second region from the charge-injection blocking layer side, and both the first region and the second region were adapted to contain a boron atom as the atom in a low concentration to control conductivity. In the second region, content of the oxygen atom, the nitrogen atom, and the boron atom was distributed in the direction of the film thickness. In contrast to this, the intermediate layer (the upper charge-injection blocking layer) put between the photoconductive layer and the surface layer reduces content of the carbon atom from the surface layer and contains the boron atom to control conductivity in a high concentration.

Table 16 shows conditions of preparation of the photosensitive layer comprising the above described charge-injection blocking layer, the photoconductive layer, the intermediate layer (the upper charge-injection blocking layer) and the surface layer.

In the present example, a cylindrical Al—Mg alloy of 1N90 as a base material with about 2 percent by weight magnesium of 108 mm in diameter, 358 mm in length and 5 mm in thickness was used as a supporting member having the crystal boundaries with 80 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.1 μm, treatment conditions of the aqueous solution of carbon dioxide, the electric conductivity, water temperature, and time in the surface treatment were adjusted.

The photoreceptor prepared was mounted on the apparatus (the Canon-made GP605 modified for experiment, image exposure was carried out by changing to laser for scanning exposure by the BAE system and the spot diameter in scanning direction was 50 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 9

In the present example, the photosensitive layer is prepared in the stratified structure comprising the charge-injection blocking layer, the photoconductive layer, the intermediate layer (the upper charge-injection blocking layer) and the surface layer. The photoconductive layer is adapted to contain the boron atom as the atom in the low concentration to control conductivity. In contrast to this, the intermediate layer (the upper charge-injection blocking layer) put between the photoconductive layer and the surface layer reduces content of the carbon atom from the surface layer and contains the boron atom to control conductivity in the high concentration.

Table 17 shows conditions of preparation of the photosensitive layer comprising the above described charge-injection blocking layer, the photoconductive layer, the intermediate layer (the upper charge-injection blocking layer) and the surface layer.

In the present example, a cylindrical Al—Mg alloy of 1N90 as a base material with about 2 percent by weight magnesium of 108 mm in diameter, 358 mm in length and 5 mm in thickness was used as a supporting member having the crystal boundaries with 100 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.2 μm, treatment conditions of the aqueous solution of carbon dioxide, the electric conductivity, water temperature, and time in the surface treatment were adjusted.

The photoreceptor prepared was mounted on the apparatus (the Canon-made GP605 modified for experiment, image exposure was carried out by changing to laser for scanning exposure by the BAE system and the spot diameter in scanning direction was 50 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

### Example 10

Using the deposition film-preparing apparatus by the VHF-PCVD method shown in FIG. 7, on the aluminum cylinder (supporting member) having a 80 mm diameter and subjected to mirror finish, the photosensitive layer comprising the charge-injection blocking layer, the photoconductive layer, and the surface layer was formed to prepare the photoreceptor. In the deposition film-preparing apparatus shown in FIG. 7, six supporting member can be installed and simultaneously, six photoreceptors were prepared.

Table 18 shows conditions of preparation of the photosensitive layer comprising the above described charge-injection blocking layer, the photoconductive layer and the surface layer.

In the present example, a cylindrical Al—Mg alloy of 1N90 as a base material with about 3 percent by weight magnesium of 80 mm in diameter, 358 mm in length and 3 mm in thickness was used as a supporting member having the crystal boundaries with 80 μm in average diameter. On the other hand, for the surface of the supporting member, following the surface treatment steps described in the above described Experimental Example 3, in order to make the height of the projected structure part of the boundary of the crystal boundary formed on the surface of the photosensitive layer to 0.3 μm, treatment conditions of the aqueous solution of carbon dioxide, the electric conductivity, water temperature, and time in the surface treatment were adjusted.

The photoreceptor prepared was mounted on the apparatus (the Canon-made NP6750 modified for experiment, image exposure was carried out by changing to laser for scanning exposure by the BAE system and the spot diameter in scanning direction was 60 μm) for electrophotography to evaluate by the same manner as that of Experimental Example 3 and the good result was obtained for both the evenness of image density, line reproducibility, and separability.

In other words, it has been known that the average diameter of the crystal boundary formed on the surface of the photosensitive layers is made larger than the spot diameter of the light beam and also, by using the photoreceptor of which the height of the projected structure of the part of the boundary between crystal boundaries is controlled to the range from 0.05 μm to 0.4 μm, good electrophotographic characteristics is yielded by the apparatus for electrophotography of the BAE system.

As described above, according to the present invention, particularly in electrophotography employing a digital type electrophotographic apparatus, according to increased higher resolution, making the diameter of the spot of the exposure light fine allows less or substantially no influence to the image quality in accordance with situation of the surface of the photoreceptor for electrophotography to provide the output image of the high quality of higher resolution and clearness.

According to the present invention, also in the electrophotographic apparatus with adopting the BAE system, higher process speed and higher resolution can be realized and in the case where the exposure light is made finely in the diameter of the spot, higher in power, and higher in illuminance, effect to the image quality according to the situation of the surface of the photoreceptor can be reduced.

The photoreceptor for electrophotography according to the present invention is adapted to be that the supporting member made of aluminum or an aluminum alloy such as Al—Mg alloy is used and surface treatment is operated by using water on the surface thereof to give a face of a crystal, which corresponds to the face of the crystal exposed on the surface of the supporting member, to the photosensitive layer deposited on the surface of the supporting member, which is subjected to such surface treatment and corresponding to the boundary of the crystal boundary, the projected structure has been formed. Particularly, assumption is made as that the height of the projected part in the projected structure formed in the above described surface of the photosensitive layer is controlled to the predetermined range and also, the average particle size of the crystal particle on the surface of the supporting member for use is selected and the average particle size of the crystal particle on the surface of the photosensitive layer corresponding thereto is assigned to the predetermined range, in the electrophotographic system using the BAE system, the excellent image quality can be achieved to yield good evenness of density of the half tone image and good line reproducibility. In addition, when continuous image formation is carried out, no adhesion of the photoreceptor to the transferring material (printing paper) occurs and separability is high to be suitable for high speed operation.

Consequently, the electrophotographic method, employing a digital exposure type electrophotographic apparatus operating scanning exposure of the BAE system, which uses such photoreceptor for electrophotography, according to the present invention has, in scanning exposure using laser showing a small light beam diameter and a high light intensity, a property to yield good evenness of image density and good line reproducibility and hence, in the future, is suitable for image formation of digital electrophotography of which high speed operation and high resolution is increasingly developed. In addition, regardless of stratification of the photosensitive layer using the amorphous silicon-based material, the effect based on the projected structure is yielded corresponding to the average particle size of the crystal particle and the boundary of the crystal boundary on the surface of the above described photosensitive layer. In combination with optimization of stratification of the photosensitive layer, the photoreceptor showing excellent electric potential property, image property, duration, and environmental properties in use can be obtained.

TABLE 1

| Number of | Average diameter |
|---|---|
| supporting | of crystal grain |
| member | boundary (μm) |
| A1 | 10 |
| A2 | 30 |
| A3 | 50 |
| A4 | 70 |
| A5 | 100 |
| A6 | 150 |
| A7 | 200 |
| A8 | 300 |

TABLE 2

| | | | |
|---|---|---|---|
| Condition | Previous | Treatment | Drying |
| of | cleaning | with carbon | |
| treatment | | dioxide | |
| | | aqueous | |
| | | solution | |
| Agent for | Aqueous | Carbon | Air |
| treat | cleaning | dioxide | |
| | agent | (electro- | |
| | | conductivity | |
| | | changed) | |
| Temperature | 30° C. | 15 to 40° C. | 80° C. |
| Pressure | | | 5 Kgf/cm² |
| Time for | 3 minutes | 20 to 300 | 1 minute |
| treatment | | seconds | |
| Others | Ultrasonic | | |
| | treatment | | |

TABLE 3

| | Charge- | | |
|---|---|---|---|
| | injection | Photo- | |
| Species and Flow rate | blocking | conductive | Surface |
| of Gas | layer | layer | layer |
| SiH₄ [mL/min(normal)] | 150 | 150 | 10 |
| H₂ [mL/min(normal)] | 450 | 900 | |
| B atom content [ppm] | 2000 | 0.8 | |
| to Si atom | | | |
| NO [mL/min(normal)] | 8 | | |
| CH₄ [mL/min(normal)] | | | 600 |
| Temperature of | 260 | 290 | 290 |
| supporting member | | | |
| [° C.] | | | |
| Pressure [Pa] | 48 | 55 | 45 |
| RF power [W] | 150 | 300 | 120 |
| Thickness of layer | 2 | 30 | 0.6 |
| [μm] | | | |

TABLE 4
IAE system/BAE system

| Number of | | |
|---|---|---|
| supporting | Evenness of | Line |
| member | image density | reproducibility |
| A1 | Δ/Δ | Δ/Δ |
| A2 | Δ/Δ | Δ/Δ |
| A3 | Δ/Δ | Δ/Δ |
| A4 | ◯/◯ | ◯/◯ |
| A5 | ⊚/⊚ | ◯/◯ |
| A6 | ⊚/⊚ | ⊚/⊚ |
| A7 | ⊚/⊚ | ⊚/⊚ |
| A8 | ⊚/⊚ | ⊚/⊚ |

TABLE 5
IAE system/BAE system

| Number of | | |
|---|---|---|
| supporting | Evenness of | Line |
| member | image density | reproducibility |
| A1 | x/x | x/x |
| A2 | Δ/Δ | Δ/Δ |
| A3 | ◯/◯ | ◯/◯ |
| A4 | ◯/◯ | ◯/◯ |
| A5 | ⊚/⊚ | ◯/◯ |
| A6 | ⊚/⊚ | ⊚/⊚ |
| A7 | ⊚/⊚ | ⊚/⊚ |
| A8 | ⊚/⊚ | ⊚/⊚ |

TABLE 6

| Number of | Height of |
|---|---|
| supporting | projected |
| member | structure (μm) |
| B1 | 0.03 |
| B2 | 0.05 |
| B3 | 0.1 |
| B4 | 0.2 |
| B5 | 0.3 |
| B6 | 0.4 |
| B7 | 0.5 |
| B8 | 0.6 |

TABLE 7

| | Charge- | | |
|---|---|---|---|
| | injection | Photo- | |
| Species and Flow rate | blocking | conductive | Surface |
| of Gas | layer | layer | layer |
| SiH₄ [mL/min(normal)] | 100 | 100 | 20 |
| H₂ | 600 | 800 | |
| [mL/min(normal)] | | | |
| B atom content | 2000 | 0.5 | |
| [ppm] to Si atom | | | |
| NO | 5 | | |
| [mL/min(normal)] | | | |
| CH₄ | | | 750 |
| [mL/min(normal)] | | | |
| Temperature of | 280 | 290 | 290 |
| supporting | | | |
| member [° C.] | | | |
| Pressure [Pa] | 50 | 58 | 48 |
| RF power [W] | 125 | 300 | 200 |
| Thickness of | 3 | 30 | 0.7 |
| layer [μm] | | | |

TABLE 8

| | | | Separa- | Separa- |
|---|---|---|---|---|
| Number of | Evenness | Line | bility | bility of |
| supporting | of image | reproduci- | of solid | solid |
| member | density | bility | white | black |
| B1 | ⊚ | ⊚ | ◯ | Δ |
| B2 | ⊚ | ⊚ | ◯ | ◯ |
| B3 | ⊚ | ⊚ | ◯ | ◯ |
| B4 | ⊚ | ⊚ | ◯ | ◯ |
| B5 | ⊚ | ◯ | ◯ | ◯ |
| B6 | ◯ | ◯ | ◯ | ◯ |
| B7 | Δ | Δ | ◯ | ◯ |
| B8 | x | x | ◯ | ◯ |

TABLE 9

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 125 | 150 | 125 | 10 |
| [mL/min(normal)] | | | | |
| H₂ | 600 | 800 | 1200 | |
| [(mL/min(normal)] | | | | |
| B atom content | 1500 | 5.0→1.5 | 0.2 | |
| [ppm] to Si atom | | | | |
| NO | 5 | | | |
| [(mL/min(normal)] | | | | |
| CH₄ | | | | 600 |
| [mL/min( normal)] | | | | |
| Temperature of | 280 | 280 | 280 | 270 |
| supporting | | | | |
| member [° C.] | | | | |
| Pressure [Pa] | 50 | 60 | 60 | 50 |
| RF power [W] | 125 | 150 | 500 | 150 |
| Thickness of | 2 | 25 | 15 | 0.6 |
| layer [μm] | | | | |

TABLE 10

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 100 | 200 | 200 | 100→ |
| [mL/min(normal)] | | | | 30→8 |
| H₂ | 600 | 1600 | 1000 | |
| [mL/min(normal)] | | | | |
| B atom content | 2300 | 1.0 | 0.1 | |
| [ppm] to Si atom | | | | |
| NO | 5 | | | |
| [mL/min(normal)] | | | | |
| CH₄ | | | | 150→350→ |
| [mL/min(normal)] | | | | 600 |
| Temperature of | 260 | 260 | 250 | 260 |
| supporting | | | | |
| member [° C.] | | | | |
| Pressure [Pa] | 45 | 55 | 55 | 45 |
| RF power [W] | 100 | 800 | 200 | 100 |
| Thickness of | 2 | 30 | 7 | 0.6 |
| layer [μm] | | | | |

TABLE 11

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 150 | 125 | 125 | 125→25→ |
| [mL/min(normal)] | | | | 10 |
| SiF₄ | 10 | 10 | 10 | 8 |
| [mL/min(normal)] | | | | |
| H₂ | 600 | 1200 | 900 | |
| [mL/min(normal)] | | | | |
| B atom content | 2000 | 1.5 | 0 | 0.2 |
| [ppm] to Si atom | | | | |
| NO | 5 | 0.5 | 0.5 | 0.3 |
| [mL/min(normal)] | | | | |
| CH₄ | | | | 50→450→ |
| [mL/min(normal)] | | | | 800 |
| Temperature of | 300 | 300 | 300 | 290 |
| supporting | | | | |
| member [° C.] | | | | |
| Pressure [Pa] | 50 | 50 | 55 | 50 |
| RF power [W] | 180 | 200 | 500 | 150 |
| Thickness of | 2 | 28 | 5 | 0.6 |
| layer [μm] | | | | |

TABLE 12

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 250 | 400 | 350 | 10 |
| [mL/min(normal)] | | | | |
| H₂ | 1000 | 2000 | 1800 | |
| [mL/min(normal)] | | | | |
| B atom content | 1200 | 0.5 | 0.1 | |
| [ppm] to Si atom | | | | |
| NO | 3 | | | |
| [mL/min(normal)] | | | | |
| NH₃ | | | | 400 |
| [mL/min(normal)] | | | | |
| Temperature of | 290 | 290 | 280 | 270 |
| supporting | | | | |
| member [° C.] | | | | |
| Pressure [Pa] | 50 | 65 | 70 | 45 |
| RF power [W] | 300 | 900 | 800 | 150 |
| Thickness of | 2 | 26 | 8 | 0.6 |
| layer [μm] | | | | |

TABLE 13

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 70 | 100 | 100 | 25 |
| [mL/min(normal)] | | | | |
| H₂ | 350 | 1200 | 900 | |
| [mL/min(normal)] | | | | |
| B atom content | 2000 | 1.2 | 0 | |
| [ppm] to Si atom | | | | |
| NO | 10 | | | 3 |
| [mL/min(normal)] | | | | |
| CH₄ | | | | 1000 |
| [mL/min(normal)] | | | | |
| Temperature of | 310 | 310 | 290 | 260 |
| supporting | | | | |
| member [° C.] | | | | |
| Pressure [Pa] | 48 | 50 | 50 | 40 |
| RF power [W] | 100 | 600 | 300 | 150 |
| Thickness of | 2 | 16 | 12 | 0.6 |
| layer [μm] | | | | |

TABLE 14

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 80 | 200 | 150 | 10 |
| [mL/min(normal)] | | | | |
| H₂ | 600 | 1200 | 1200 | |
| [mL/min(normal)] | | | | |
| B atom content | 1200 | 3.0→1.0 | 0 | |
| [ppm] to Si atom | | | | |
| NO | 5 | | | |
| [mL/min(normal)] | | | | |
| CH₄ | | 5 | 2 | 600 |
| [mL/min(normal)] | | | | |
| Temperature of | 300 | 300 | 280 | 270 |
| supporting | | | | |
| member [° C.] | | | | |
| Pressure [Pa] | 50 | 60 | 60 | 50 |
| RF power [W] | 100 | 600 | 150 | 150 |
| Thickness of | 2 | 23 | 5 | 0.6 |
| layer [μm] | | | | |

TABLE 15

| | Charge- | Photoconductive | | |
|---|---|---|---|---|
| | injection | layer | | |
| Species and Flow | blocking | First | Second | Surface |
| rate of Gas | layer | region | region | layer |
| SiH₄ | 100 | 100 | 100 | 10 |
| [mL/min( normal)] | | | | |
| H₂ | 600 | 800 | 600 | |
| [mL/min( normal)] | | | | |
| B atom content | 2000 | 0 | 1.0 | |
| [ppm] to Si atom | | | | |
| NO | 5 | | | |
| [mL/min( normal)] | | | | |
| GeH₄ | | | 10 | |
| [mL/min( normal)] | | | | |
| CH₄ | | | | 500 |
| [mL/min( normal)] | | | | |
| Temperature of | 290 | 250 | 250 | 290 |
| supporting | | | | |
| member [° C.] | | | | |
| Pressure [Pa] | 67 | 65 | 67 | 55 |
| RF power [W] | 100 | 100 | 100 | 150 |
| Thickness of | 2 | 25 | 5 | 0.6 |
| layer [μm] | | | | |

TABLE 16

| | Charge- | Photoconductive | | | |
|---|---|---|---|---|---|
| Gas species | injection | layer | | | |
| and | blocking | First | Second | Middle | Surface |
| Conditions | layer | region | region | layer | layer |
| SiH₄ | 200 | 200 | 200 | 100 | 100→5 |
| [mL/min | | | | | |
| (normal)] | | | | | |
| H₂ [mL/min | 500 | 1000 | | | |
| (normal)] | | | | | |
| He [mL/min | | | 300 | | |
| (normal)] | | | | | |
| P atom | 300 | | | | |
| content | | | | | |
| [ppm] to Si | | | | | |
| atom | | | | | |
| B atom | | 0.1 | 0.1→ | 300 | |
| content | | | 0.01 | | |
| [ppm] to Si | | | | | |
| atom | | | | | |
| NO (for | 0.1% | 120→ | 140→ | | |
| SiH₄) | | 65 ppm | 75 ppm | | |
| CH₄ [mL/min | | | | 200 | 200→ |
| (normal)] | | | | | 500 |
| Temperature | 280 | 280 | 260 | 260 | 260 |
| of | | | | | |
| supporting | | | | | |
| member [° C.] | | | | | |
| Pressure | 60 | 65 | 45 | 55 | 55 |
| [Pa] | | | | | |
| RF power | 200 | 300 | 300 | 200 | 150 |
| [W] | | | | | |
| Thickness | 3 | 25 | 3 | 0.3 | 0.5 |
| of layer | | | | | |
| [μm] | | | | | |

TABLE 17

| | | | Upper | |
|---|---|---|---|---|
| | Charge- | | charge- | |
| Species and | injection | Photo- | injection | |
| Flow rate of | blocking | conductive | blocking | Surface |
| Gas | layer | layer | layer | layer |
| SiH₄ [mL/min | 150 | 250 | 125 | 25 |
| (normal)] | | | | |
| H₂ [mL/min | 400 | 800 | | |
| (normal)] | | | | |
| P atom | 1500 | | | |
| content | | | | |
| [ppm] to Si | | | | |
| atom | | | | |
| B atom | | 1.5 | 1000 | |
| content | | | | |
| [ppm] to Si | | | | |
| atom | | | | |
| NO [mL/min | 10 | | | 5 |
| (normal)] | | | | |
| CH₄ [mL/min | 1 | 1 | 600 | 500→ |
| (normal)] | | | | 600 |
| Temperature | 270 | 260 | 250 | 250 |
| of | | | | |
| supporting | | | | |
| member [° C.] | | | | |
| Pressure | 40 | 53 | 55 | 60 |
| [Pa] | | | | |
| RF power [W] | 400 | 650 | 300 | 150 |
| Thickness of | 3 | 30 | 0.1 | 0.7 |
| layer [μm] | | | | |

TABLE 18

| | Charge- | | |
|---|---|---|---|
| | injection | | |
| Species and Flow | blocking | Photoconductive | Surface |
| rate of Gas | layer | layer | layer |
| SiH₄ | 300 | 300 | 30 |
| [mL/min( normal)] | | | |
| B atom content | 3000 | 2 | 0 |
| [ppm] to Si atom | | | |
| NO | 9 | 0 | 0 |
| [mL/min( normal)] | | | |
| CH₄ | 0 | 0 | 70 |
| [mL/min( normal)] | | | |
| Temperature of | 280 | 270 | 250 |
| supporting | | | |
| member [° C.] | | | |
| Pressure [Pa] | 1.1 | 1.1 | 1.4 |
| High-frequency | 1500 | 1500 | 1300 |
| power [W] | | | |
| Thickness of | 3 | 25 | 0.5 |
| layer [μm] | | | |

What is claimed is:

1. An electrophotographic method in which an electrophotographic apparatus comprising a photoreceptor for electrophotography, an image forming light irradiation means and a developing means is used and a step of forming an image is comprised, the step of forming an image comprising the steps of forming a static latent image on the photoreceptor by the image forming light irradiation means based on a background exposure method for scan-exposing a non-image portion comprised of a background portion and visualizing the static latent image by the developing means, wherein
the photoreceptor comprises a supporting member and a photosensitive layer, which supporting member is comprised of aluminum or an aluminum alloy and has a surface being subjected to a surface treatment using water before forming the photosensitive layer and exposing aluminum crystal grain boundaries thereon, and which photosensitive layer is formed on the supporting member, contains amorphous silicon and has a surface exposing thereon crystal grain boundaries corresponding to the aluminum crystal grain boundaries on the supporting member surface; and
an average grain size of crystal grains represented by the crystal grain boundaries exposed on the photosensitive layer surface is larger than a diameter of a spot of a light beam for exposure of the image forming light irradiation means which diameter is a spot width equal to 1/e² of a peak intensity; and convex portions corresponding to the crystal grain boundaries exposed on the photosensitive layer surface are disposed on the photosensitive layer surface.

2. The electrophotographic method according to claim 1, wherein a height of said convex portion is set within the range of not less than 0.05 μm and not more than 0.4 μm.

3. The electrophotographic method according to claim 1,
wherein aluminum grains represented by said aluminum crystal grain boundaries exposed on said supporting member have an average grain size larger than said diameter of the spot of said light beam for exposure.

4. The electrophotographic method according to claim 1,
wherein said light beam for exposure is a laser beam.

5. The electrophotographic method according to claim 1,
wherein said surface treatment using water includes a treatment using a treatment liquid comprising a detergent dissolved into water having a resistivity of not less than 1 MΩ·cm (25° C.).

6. A photoreceptor for electrophotography comprising a supporting member comprising aluminum or an aluminum alloy and a photosensitive layer containing amorphous silicon and being formed on the supporting member, wherein
the supporting member has a surface subjected to a surface treatment using water; convex portions are formed on a surface of the photosensitive layer, corresponding to crystal grain boundaries of aluminum exposed on the supporting member surface; and a height of the convex portions is set within the range of not less than 0.05 μm and not more than 0.4 μm.

7. The photoreceptor for electrophotography according to claim 6, wherein said surface treatment using water includes a treatment using a treatment liquid comprising a detergent dissolved into water having a resistivity of 1 MΩ·cm (25° C.).
